(19) United States
(12) Patent Application Publication
(10) Pub. No.: US 2018/0190010 A1
(43) Pub. Date: Jul. 5, 2018

(54) METHOD FOR PROVIDING VIRTUAL SPACE, PROGRAM FOR EXECUTING THE METHOD ON COMPUTER, AND INFORMATION PROCESSING APPARATUS FOR EXECUTING THE PROGRAM

(71) Applicant: COLOPL, Inc., Tokyo (JP)

(72) Inventors: Kazuaki SAWAKI, Tokyo (JP); Eita KIKUCHI, Tokyo (JP)

(21) Appl. No.: 15/851,286

(22) Filed: Dec. 21, 2017

(30) Foreign Application Priority Data
Dec. 22, 2016 (JP) 2016-249394

(51) Int. Cl. G06T 15/10; G06F 3/01; G06T 13/40; G06T 19/00; H04N 5/232; G06K 9/00

(52) U.S. Cl. CPC G06T 15/10; G06F 3/011; G06K 9/00201; G06T 19/006; H04N 5/23238; G06T 13/40

(57) ABSTRACT

[Object] To provide a technology capable of enhancing a user's experience in a virtual space.

[Solving means] A method for adjusting a size of an avatar object in a virtual space includes the steps of: forming (Step S2010) a virtual space with use of a panorama image; displaying (S2030) a part of the panorama image on a head-mounted device; detecting (S2036) a motion of a head of a user wearing the head-mounted device; updating (S2050) a part of the panorama image displayed on the head-mounted device in association with the detected motion; arranging (S2026) an avatar object of a user communicating via the virtual space in the virtual space; and adjusting (S2028) a size of the avatar object based on information associated with the panorama image.

### TECHNICAL FIELD

This disclosure relates to a technology of controlling an avatar arranged in a virtual space, and more particularly, to a technology of controlling a facial expression of the avatar.

### BACKGROUND ART

There is known a technology of providing a virtual space (virtual reality) with use of a head-mounted device (HMD). There is proposed a technology of arranging respective avatars of a plurality of users in a virtual space.

### RELATED ART

### Patent Documents

[Patent Document 1] JP 2003-141563 A

### SUMMARY

### Problem to be Solved

According to one embodiment of this disclosure, there is provided a method. The method is a method to be executed by a computer including a processor and a memory, the method including:

storing, into the memory, data for defining each of a panorama image, first information associated in advance with the panorama image, an avatar object having a predetermined size, and a point of view;

forming a virtual space with use of the panorama image;

adjusting a size of the avatar object so as to correspond to the first information;

arranging the avatar object having the adjusted size in the virtual space;

detecting a motion of a head-mounted device (HMD);

defining a field of view from the point of view based on the detected motion of the HMD;

generating a field-of-view image corresponding to the field of view; and

displaying the field-of-view image on the HMD.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram for illustrating an overview of a configuration of an HMD system in one embodiment of this disclosure.

FIG. 2 A block diagram for illustrating an example of a hardware configuration of a computer in one embodiment of this disclosure.

FIG. 3 A diagram for schematically illustrating a uvw visual-field coordinate system to be set for an HMD in one embodiment of this disclosure.

FIG. 4 A diagram for schematically illustrating one mode of expressing a virtual space in one embodiment of this disclosure.

FIG. 5 A diagram for illustrating, from above, a head of a user wearing the HMD in one embodiment of this disclosure.

FIG. 6 A diagram for illustrating a YZ cross section obtained by viewing a field-of-view region from an X direction in the virtual space.

FIG. 7 A diagram for illustrating an XZ cross section obtained by viewing the field-of-view region from a Y direction in the virtual space.

FIG. 8A Diagrams for illustrating a schematic configuration of a controller in one embodiment of this disclosure.

FIG. 8B A diagram for illustrating an example of a yaw direction, a roll direction, and a pitch direction that are defined with respect to a right hand of the user in one embodiment of this disclosure.

FIG. 9 A block diagram for illustrating an example of a hardware configuration of a server in one embodiment of this disclosure.

FIG. 10 A block diagram for illustrating a computer in one embodiment of this disclosure in terms of its module configuration.

FIG. 11 A sequence chart for illustrating a part of processing to be executed by an HMD set in one embodiment of this disclosure.

FIG. 12A Schematic diagrams for illustrating a situation in which each HMD provides the user with the virtual space in a network.

FIG. 12B A diagram for illustrating a field-of-view image of a user 5A in FIG. 12A.

FIG. 13 A sequence diagram for illustrating processing to be executed by the HMD system in one embodiment of this disclosure.

FIG. 14 A block diagram for illustrating the detailed configuration of modules of the computer in one embodiment of this disclosure.

FIG. 15 A flowchart for illustrating processing to be executed by the HMD set.

FIG. 16A A diagram for illustrating avatar objects of respective users of the HMD sets.

FIG. 16B A diagram for illustrating a field-of-view image of the user.

FIG. 17A A diagram for illustrating a field-of-view image including an avatar object obtained before adjustment of the size.

FIG. 17B A diagram for illustrating a field-of-view image including an avatar object obtained after adjustment of the size.

FIG. 18 A diagram for illustrating a hardware configuration and a module configuration of the server.

FIG. 19 A diagram for illustrating a data structure example of a panorama image DB.

FIG. 20 A flowchart for illustrating control of adjusting the size of the avatar object in the virtual space.

FIG. 21 A diagram for illustrating information for identifying an object included in a panorama image.

FIG. 22 A diagram for illustrating a data structure example of the panorama image DB.

FIG. 23 A flowchart for illustrating processing of determining a display magnification of the avatar object by the server in Step S2012 of FIG. 20.

FIG. 24 A diagram for illustrating processing of adjusting the size of the avatar object.

FIG. 25 A diagram for illustrating a data structure example of a template DB in one embodiment of this disclosure.

FIG. 26 A flowchart for illustrating processing of determining the display magnification of the avatar object by the server in Step S2012 of FIG. 20.

### DESCRIPTION OF EMBODIMENTS

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

### Configuration of HMD System

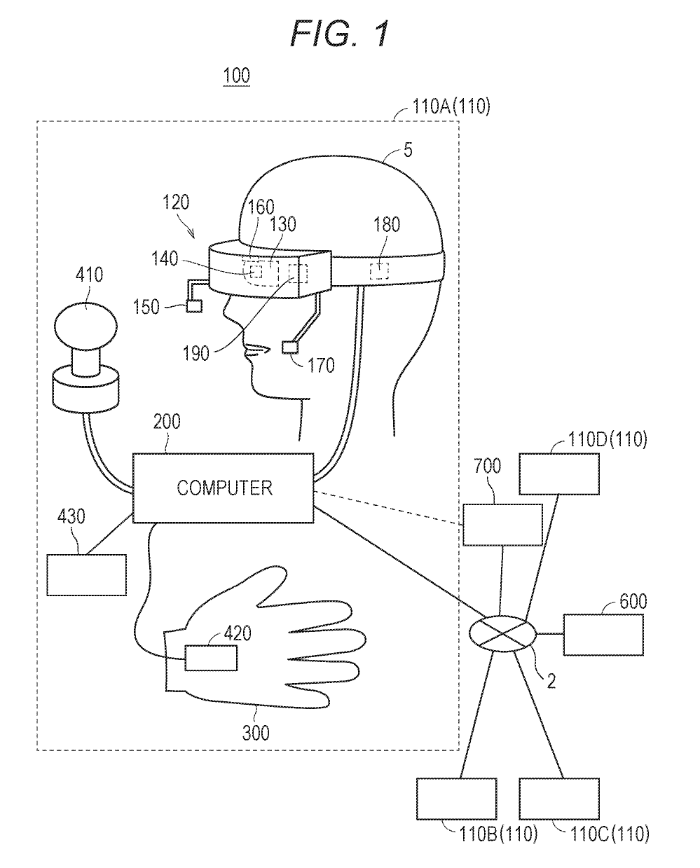

With reference to FIG. 1, a configuration of a head-mounted device (HMD) system 100 is described. FIG. 1 is a diagram for illustrating an overview of the configuration of the HMD system 100 in one embodiment of this disclosure. The HMD system 100 is provided as a system for household use or a system for professional use.

The HMD system 100 includes a server 600, HMD sets 110A, 110B, 110C, and 110D, an external device 700, and a network 2. Each of the HMD sets 110A, 110B, 110C, and 110D is capable of communicating to/from the server 600 or the external device 700 via the network 2. In the following, the HMD sets 110A, 110B, 110C, and 110D are also collectively referred to as “HMD set 110”. The number of HMD sets 110 constructing the HMD system 100 is not limited to four, but maybe three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. The controller 300 may include a motion sensor 420.

In one aspect, the computer 200 can be connected to the network 2, for example, the Internet, and can communicate to/from the server 600 or other computers connected to the network 2. Examples of the other computers include a computer of another HMD set 110 and the external device 700. In another aspect, the HMD 120 may include a sensor 190 instead of the HMD sensor 410.

The HMD 120 may be worn on a head of a user 5 to provide a virtual space to the user 5 during operation. More specifically, the HMD 120 displays each of a right-eye image and a left-eye image on the monitor 130. When each eye of the user 5 visually recognizes each image, the user 5 may recognize the image as a three-dimensional image based on the parallax of both the eyes. The HMD 120 may include any one of a so-called head-mounted display including a monitor and a head-mounted device capable of mounting a smartphone or other terminals including a monitor.

The monitor 130 is implemented as, for example, a non-transmissive display device. In one aspect, the monitor 130 is arranged on a main body of the HMD 120 so as to be positioned in front of both the eyes of the user 5. Therefore, when the user 5 visually recognizes the three-dimensional image displayed on the monitor 130, the user 5 can be immersed in the virtual space. In one aspect, the virtual space includes, for example, a background, objects that can be operated by the user 5, and menu images that can be selected by the user 5. In one aspect, the monitor 130 may be implemented as a liquid crystal monitor or an organic electroluminescence (EL) monitor included in a so-called smartphone or other information display terminals.

In another aspect, the monitor 130 may be implemented as a transmissive display device. In this case, the HMD 120 is not a non-see-through HMD covering the eyes of the user 5 illustrated in FIG. 1, but maybe a see-through HMD, for example, smartglasses. The transmissive monitor 130 may be configured as a temporarily non-transmissive display device through adjustment of a transmittance thereof. The monitor 130 may be configured to display a real space and a part of an image constructing the virtual space at the same time. For example, the monitor 130 may display an image of the real space captured by a camera mounted on the HMD 120, or may enable recognition of the real space by setting the transmittance of a part the monitor 130 high.

In one aspect, the monitor 130 may include a sub-monitor for displaying a right-eye image and a sub-monitor for displaying a left-eye image. In another aspect, the monitor 130 may be configured to integrally display the right-eye image and the left-eye image. In this case, the monitor 130 includes a high-speed shutter. The high-speed shutter operates so as to enable alternate display of the right-eye image and the left-eye image so that only one of the eyes can recognize the image.

In one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In another aspect, the HMD sensor 410 may be implemented by a camera. In this case, the HMD sensor 410 may use image information of the HMD 120 output from the camera to execute image analysis processing, to thereby enable detection of the position and the inclination of the HMD 120.

In another aspect, the HMD 120 may include the sensor 190 instead of, or in addition to, the HMD sensor 410 as a position detector. The HMD 120 may use the sensor 190 to detect the position and the inclination of the HMD 120 itself. For example, when the sensor 190 is an angular velocity sensor, a geomagnetic sensor, or an acceleration sensor, the HMD 120 may use any of those sensors instead of the HMD sensor 410 to detect the position and the inclination of the HMD 120 itself. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5 . The direction of the line of sight is detected by, for example, a known eye tracking function. The eye gaze sensor 140 is implemented by a sensor having the eye tracking function. In one aspect, the eye gaze sensor 140 is preferred to include a right-eye sensor and a left-eye sensor. The eye gaze sensor 140 may be, for example, a sensor configured to irradiate the right eye and the left eye of the user 5 with an infrared ray, and to receive reflection light from the cornea and the iris with respect to the irradiation light, to thereby detect a rotational angle of each eyeball. The eye gaze sensor 140 can detect the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In one aspect, the first camera 150 may be arranged outside of the HMD 120, and the second camera 160 may be arranged inside of the HMD 120. Images generated by the first camera 150 and the second camera 160 are input to the computer 200. In another aspect, the first camera 150 and the second camera 160 may be implemented as one camera, and the face of the user 5 may be photographed with this one camera.

The microphone 170 converts an utterance of the user 5 into a voice signal (electric signal) for output to the computer 200. The speaker 180 converts the voice signal into a voice for output to the user 5. In another aspect, the HMD 120 may include earphones in place of the speaker 180.

The controller 300 is connected to the computer 200 through wired or wireless communication. The controller 300 receives input of a command from the user 5 to the computer 200. In one aspect, the controller 300 can be held by the user 5. In another aspect, the controller 300 can be mounted to the body or a part of the clothes of the user 5. In still another aspect, the controller 300 may be configured to output at least any one of a vibration, a sound, or light based on the signal transmitted from the computer 200. In yet another aspect, the controller 300 receives from the user 5 an operation for controlling the position and the motion of an object arranged in the virtual space.

In one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In another aspect, the HMD sensor 410 may be implemented by a camera. In this case, the HMD sensor 410 may use image information of the controller 300 output from the camera to execute image analysis processing, to thereby enable detection of the position and the inclination of the controller 300.

In one aspect, the motion sensor 420 is mounted on the hand of the user 5 to detect the motion of the hand of the user 5. For example, the motion sensor 420 detects a rotational speed and the number of rotations of the hand. The detected signal is transmitted to the computer 200. The motion sensor 420 is provided to, for example, the controller 300. In one aspect, the motion sensor 420 is provided to, for example, the controller 300 capable of being held by the user 5. In another aspect, for the safety in the real space, the controller 300 is mounted on an object like a glove-type object that does not easily fly away by being worn on a hand of the user 5. In still another aspect, a sensor that is not mounted on the user 5 may detect the motion of the hand of the user 5. For example, a signal of a camera that photographs the user 5 may be input to the computer 200 as a signal representing the motion of the user 5. As one example, the motion sensor 420 and the computer 200 are connected to each other through wireless communication. In the case of wireless communication, the communication mode is not particularly limited, and for example, Bluetooth (trademark) or other known communication methods are used.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

The server 600 may transmit a program to the computer 200. In another aspect, the server 600 may communicate to/from another computer 200 for providing virtual reality to the HMD 120 used by another user. For example, when a plurality of users play a participatory game in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 maybe any device as long as the external device 700 can communicate to/from the computer 200. The external device 700 may be, for example, a device capable of communicating to/from the computer 200 via the network 2, or may be a device capable of directly communicating to/from the computer 200 by near field communication or wired communication. Peripheral devices such as a smart device, a personal computer (PC) , and the computer 200 may be used as the external device 700, but the external device 700 is not limited thereto.

### Hardware Configuration of Computer

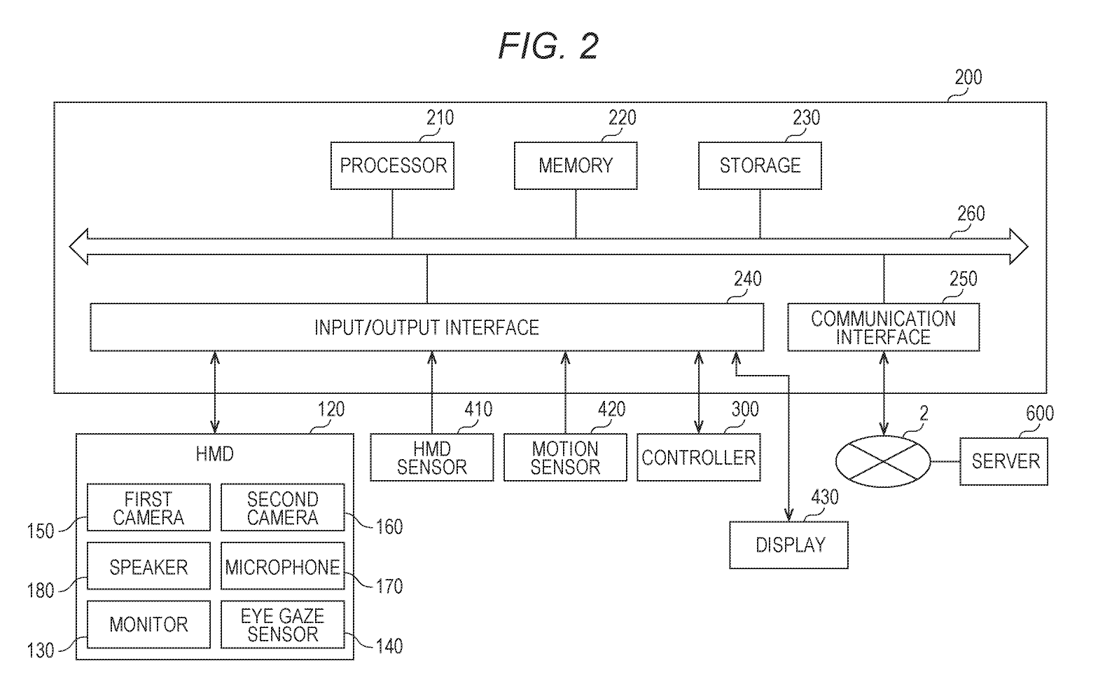

With reference to FIG. 2, the computer 200 in this embodiment is described. FIG. 2 is a block diagram for illustrating an example of the hardware configuration of the computer 200 in this embodiment. The computer 200 includes, as primary components, a processor 210, a memory 220, a storage 230, an input/output interface 240, and a communication interface 250. Each component is connected to a bus 260.

The processor 210 executes a series of commands included in a program stored in the memory 220 or the storage 230 based on a signal transmitted to the computer 200 or on satisfaction of a condition determined in advance. In one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In one aspect, the memory 220 is implemented as a random access memory (RAM) or other volatile memories.

The storage 230 permanently stores programs and data. The storage 230 is implemented as, for example, a read-only memory (ROM), a hard disk device, a flash memory, or other non-volatile storage devices. The programs stored in the storage 230 include programs for providing a virtual space in the HMD system 100, simulation programs, game programs, user authentication programs, and programs for implementing communication to/from other computers 200. The data stored in the storage 230 includes data and objects for defining the virtual space.

In another aspect, the storage 230 may be implemented as a removable storage device like a memory card. In still another aspect, a configuration that uses programs and data stored in an external storage device may be used instead of the storage 230 built into the computer 200. With such a configuration, for example, in a situation in which a plurality of HMD systems 100 are used as in an amusement facility, the programs and the data can be collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In one aspect, the input/output interface 240 is implemented with use of a universal serial bus (USB), a digital visual interface (DVI), a high-definition multimedia interface (HDMI) (trademark), or other terminals. The input/output interface 240 is not limited to ones described above.

In one aspect, the input/output interface 240 may further communicate to/from the controller 300. For example, the input/output interface 240 receives input of a signal output from the controller 300 and the motion sensor 420. In another aspect, the input/output interface 240 transmits a command output from the processor 210 to the controller 300. The command instructs the controller 300 to, for example, vibrate, output a sound, or emit light. When the controller 300 receives the command, the controller 300 executes anyone of vibration, sound output, and light emission in accordance with the command.

The communication interface 250 is connected to the network 2 to communicate to/from other computers (e.g., server 600) connected to the network 2. In one aspect, the communication interface 250 is implemented as, for example, a local area network (LAN), other wired communication interfaces, wireless fidelity (Wi-Fi), Bluetooth (trademark), near field communication (NFC), or other wireless communication interfaces. The communication interface 250 is not limited to ones described above.

In one aspect, the processor 210 accesses the storage 230 and loads one or more programs stored in the storage 230 to the memory 220 to execute a series of commands included in the program. The one or more programs may include an operating system of the computer 200, an application program for providing a virtual space, and game software that can be executed in the virtual space. The processor 210 transmits a signal for providing a virtual space to the HMD 120 via the input/output interface 240. The HMD 120 displays a video on the monitor 130 based on the signal.

In the example illustrated in FIG. 2, the computer 200 is provided outside of the HMD 120, but in another aspect, the computer 200 may be built into the HMD 120. As an example, a portable information communication terminal (e.g., smartphone) including the monitor 130 may function as the computer 200.

The computer 200 may be used in common among a plurality of HMDs 120. With such a configuration, for example, the same virtual space can be provided to a plurality of users, and hence each user can enjoy the same application with other users in the same virtual space.

According to one embodiment of this disclosure, in the HMD system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which correspond to the motion of the user 5 wearing the HMD 120, based on the value of each point (each coordinate value in the real coordinate system). In more detail, the HMD sensor 410 can detect the temporal change of the position and the inclination of the HMD 120 with use of each value detected over time.

Each inclination of the HMD 120 detected by the HMD sensor 410 corresponds to each inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

### Uvw Visual-field Coordinate System

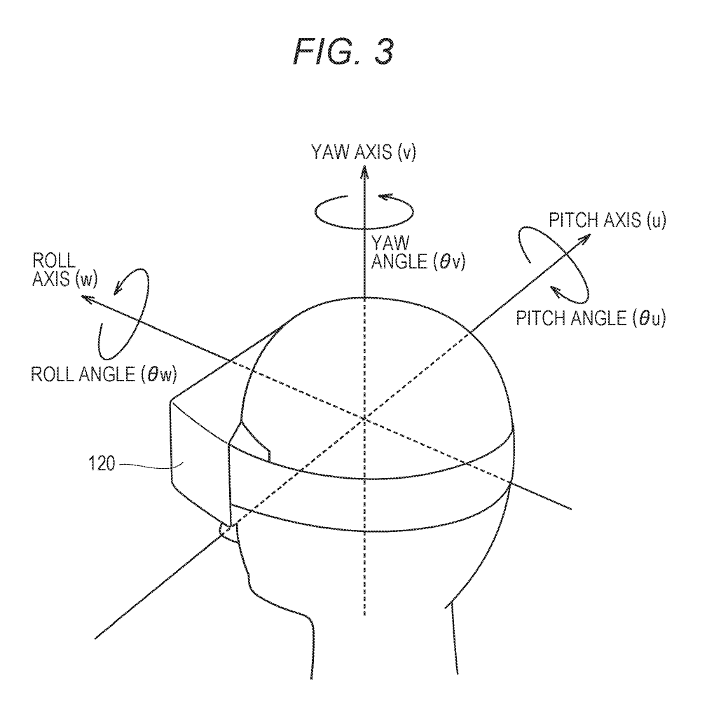

With reference to FIG. 3, the uvw visual-field coordinate system is described. FIG. 3 is a diagram for schematically illustrating a uvw visual-field coordinate system to be set for the HMD 120 in one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

As illustrated in FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In one aspect, when the user 5 wearing the HMD 120 is standing upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 can detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is always constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In one aspect, the HMD sensor 410 may identify the position of the HMD 120 in the real space as a position relative to the HMD sensor 410 based on the light intensity of the infrared ray or a relative positional relationship between a plurality of points (e.g., distance between points), which is acquired based on output from the infrared sensor. The processor 210 may determine the origin of the uvw visual-field coordinate system of the HMD 120 in the real space (real coordinate system) based on the identified relative position.

### Virtual Space

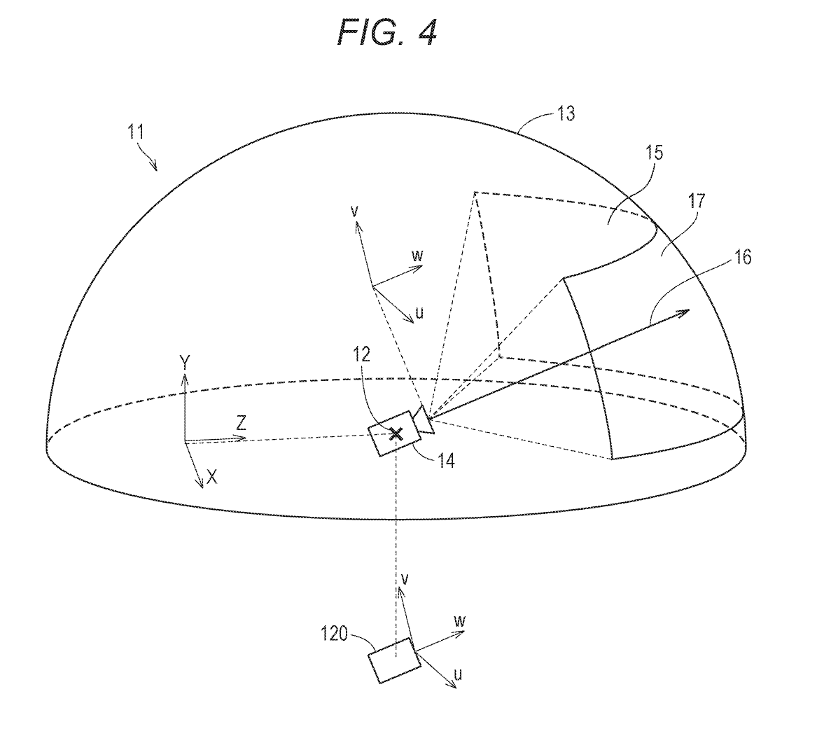

With reference to FIG. 4, the virtual space is further described. FIG. 4 is a diagram for schematically illustrating one mode of expressing a virtual space 11 in one embodiment of this disclosure. The virtual space 11 has a structure with an entire celestial sphere shape covering a center 12 in all 360-degree directions. In FIG. 4, in order to avoid complicated description, only the upper-half celestial sphere of the virtual space 11 is exemplified. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that can be developed in the virtual space 11 with each corresponding mesh section in the virtual space 11.

In one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space maybe reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 can be said to be a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the HMD system 100 in one aspect, the line of sight of the user 5 detected by the eye gaze sensor 140 can be regarded as the line of sight of the user 5 in the uvw visual-field coordinate system of the virtual camera 14.

### User's Line of Sight

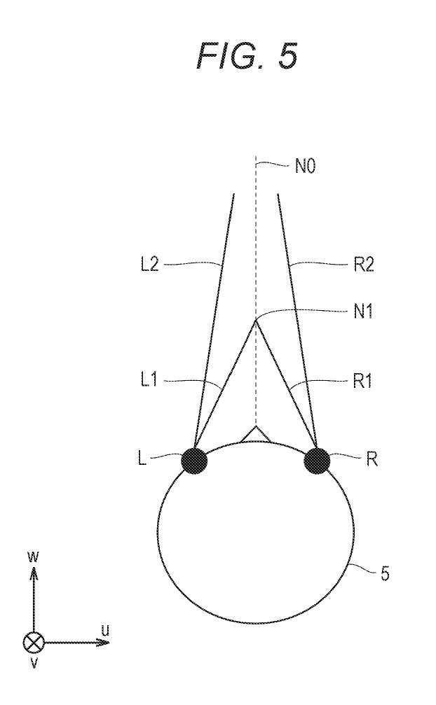

With reference to FIG. 5, determination of the line of sight of the user 5 is described. FIG. 5 is a diagram for illustrating, from above, the head of the user 5 wearing the HMD 120 in one embodiment of this disclosure.

In one aspect, the eye gaze sensor 140 detects lines of sight of the right eye and the left eye of the user 5. In one aspect, when the user 5 is looking at a near place, the eye gaze sensor 140 detects lines of sight R1 and L1. In another aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In another aspect, the HMD system 100 may include a television broadcast reception tuner. With such a configuration, the HMD system 100 can display a television program in the virtual space 11.

In still another aspect, the HMD system 100 may include a communication circuit for connecting to the Internet or have a verbal communication function for connecting to a telephone line.

### Field-of-View Region

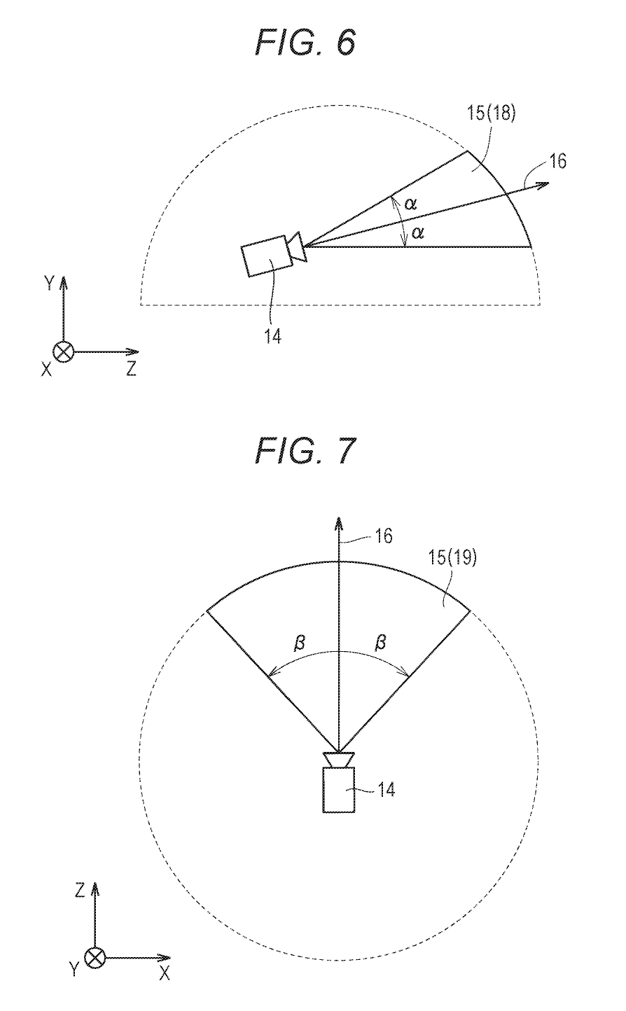

With reference to FIG. 6 and FIG. 7, the field-of-view region 15 is described. FIG. 6 is a diagram for illustrating a YZ cross section obtained by viewing the field-of-view region 15 from an X direction in the virtual space 11. FIG. 7 is a diagram for illustrating an XZ cross section obtained by viewing the field-of-view region 15 from a Y direction in the virtual space 11.

As illustrated in FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

As illustrated in FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In one aspect, the HMD system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120, the user 5 can visually recognize only the panorama image 13 developed in the virtual space 11 without visually recognizing the real world. Therefore, the HMD system 100 can provide a high sense of immersion in the virtual space 11 to the user 5.

In one aspect, the processor 210 may move the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In one aspect, the virtual camera 14 may include two virtual cameras, that is, a virtual camera for providing a right-eye image and a virtual camera for providing a left-eye image. An appropriate parallax is set for the two virtual cameras so that the user 5 can recognize the three-dimensional virtual space 11. In another aspect, the virtual camera 14 may be implemented by one virtual camera. In this case, a right-eye image and a left-eye image may be generated from an image acquired by one virtual camera. In this embodiment, the technical idea of this disclosure is exemplified assuming that the virtual camera 14 includes two virtual cameras, and the roll axes of the two virtual cameras are synthesized so that the generated roll axis (w) is adapted to the roll axis (w) of the HMD 120.

### Controller

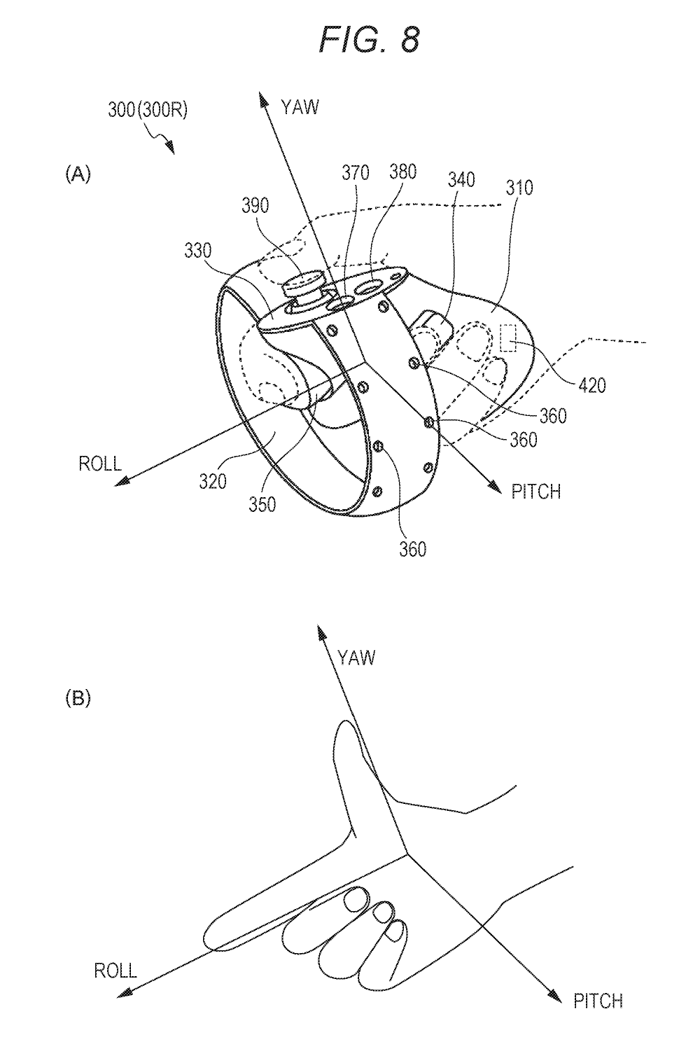

An example of the controller 300 is described with reference to FIGS. 8. FIGS. 8 are diagrams for illustrating a schematic configuration of the controller 300 in one embodiment of this disclosure.

As illustrated in FIGS. 8, in one aspect, the controller 300 may include a right controller 300R and a left controller (not shown). The right controller 300R is operated by the right hand of the user 5. The left controller is operated by the left hand of the user 5. In one aspect, the right controller 300R and the left controller are symmetrically configured as separate devices. Therefore, the user 5 can freely move his or her right hand holding the right controller 300R and his or her left hand holding the left controller. In another aspect, the controller 300 may be an integrated controller configured to receive an operation performed by both hands. The right controller 300R is now described.

The right controller 300R includes a grip 310, a frame 320, and a top surface 330. The grip 310 is configured so as to be held by the right hand of the user 5. For example, the grip 310 may be held by the palm and three fingers (middle finger, ring finger, and small finger) of the right hand of the user 5.

The grip 310 includes buttons 340 and 350 and the motion sensor 420. The button 340 is arranged on a side surface of the grip 310, and receives an operation performed by the middle finger of the right hand. The button 350 is arranged on a front surface of the grip 310, and receives an operation performed by the index finger of the right hand. In one aspect, the buttons 340 and 350 are configured as trigger type buttons. The motion sensor 420 is built into the casing of the grip 310. When a motion of the user 5 can be detected from the surroundings of the user 5 by a camera or other device, it is not required for the grip 310 to include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 may be used to detect the position and the posture (inclination and direction) of each of the right controller 300R and the left controller. In the example illustrated in FIGS. 8, the infrared LEDs 360 are shown as being arranged in two rows, but the number of arrangement rows is not limited to that illustrated in FIGS. 8. The infrared LEDs 360 may be arranged in one row or in three or more rows.

The top surface 330 includes buttons 370 and 380 and an analog stick 390 . The buttons 370 and 380 are configured as push type buttons. The buttons 370 and 380 receive an operation performed by the thumb of the right hand of the user 5. In one aspect, the analog stick 390 receives an operation performed in any direction of 360 degrees from an initial position (neutral position) . The operation includes, for example, an operation for moving an object arranged in the virtual space 11.

In one aspect, each of the right controller 300R and the left controller includes a battery for driving the infrared ray LEDs 360 and other members. The battery includes, for example, a rechargeable battery, a button battery, a dry battery, but the battery is not limited thereto. In another aspect, the right controller 300R and the left controller may be connected to, for example, a USB interface of the computer 200. In this case, the right controller 300R and the left controller do not require a battery.

In FIG. 8A and FIG. 8B, for example, a yaw direction, a roll direction, and a pitch direction are defined with respect to the right hand of the user 5. A direction of extending the thumb, a direction of extending the index finger, and a direction perpendicular to a plane defined by the yaw-direction axis and the roll-direction axis when the user 5 extends his or her thumb and index finger are defined as the yaw direction, the roll direction, and the pitch direction, respectively.

### Hardware Configuration of Server

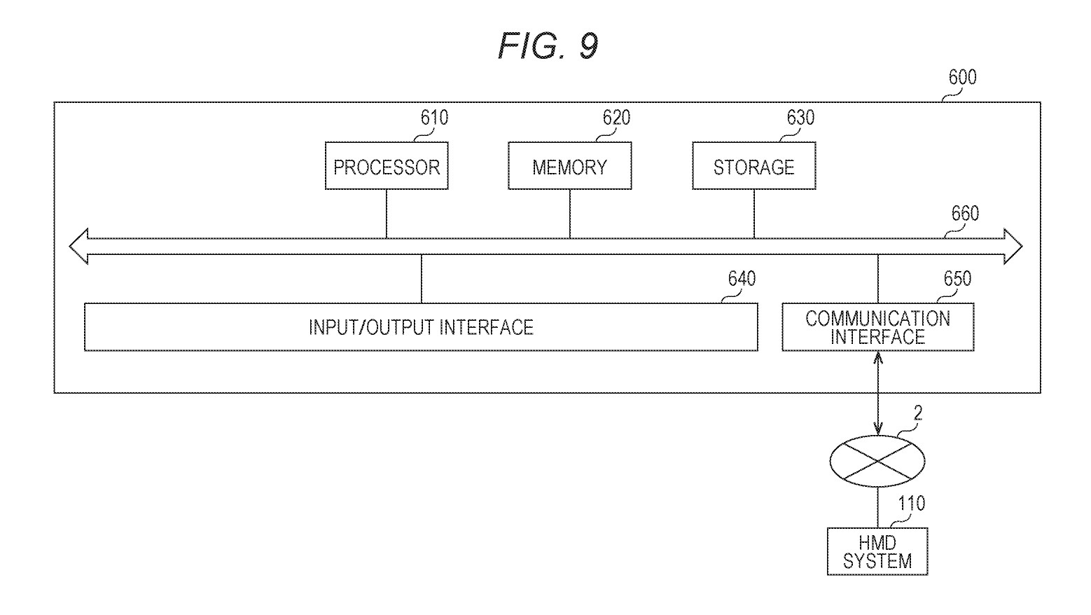

With reference to FIG. 9, the server 10 in this embodiment is described. FIG. 9 is a block diagram for illustrating an example of a hardware configuration of the server 600 in one embodiment of this disclosure. The server 600 includes, as primary components, a processor 610, a memory 620, a storage 630, an input/output interface 640, and a communication interface 650. Each component is connected to a bus 660.

The processor 610 executes a series of commands included in a program stored in the memory 620 or the storage 630 based on a signal transmitted to the server 600 or on satisfaction of a condition determined in advance. In one aspect, the processor 10 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In one aspect, the memory 620 is implemented as a random access memory (RAM) or other volatile memories.

The storage 630 permanently stores programs and data. The storage 630 is implemented as, for example, a read-only memory (ROM), a hard disk device, a flash memory, or other non-volatile storage devices. The programs stored in the storage 630 include programs for providing a virtual space in the HMD system 100, simulation programs, game programs, user authentication programs, and programs for implementing communication to/from other computers 200. The data stored in the storage 630 may include, for example, data and objects for defining the virtual space.

In another aspect, the storage 630 may be implemented as a removable storage device like a memory card. In another aspect, a configuration that uses programs and data stored in an external storage device may be used instead of the storage 630 built into the server 600. With such a configuration, for example, in a situation in which a plurality of HMD systems 100 are used as in an amusement facility, the programs and the data can be collectively updated.

The input/output interface 640 allows communication of signals to/from an input/output device. In one aspect, the input/output interface 640 is implemented with use of a USB, a DVI, an HDMI, or other terminals. The input/output interface 640 is not limited to ones described above.

The communication interface 650 is connected to the network 2 to communicate to/from the computer 200 connected to the network 2. In one aspect, the communication interface 650 is implemented as, for example, a LAN, other wired communication interfaces, Wi-Fi, Bluetooth, NFC, or other wireless communication interfaces. The communication interface 650 is not limited to ones described above.

In one aspect, the processor 610 accesses the storage 630 and loads one or more programs stored in the storage 630 to the memory 620 to execute a series of commands included in the program. The one or more programs may include, for example, an operating system of the server 610, an application program for providing a virtual space, and game software that can be executed in the virtual space. The processor 610 may transmit a signal for providing a virtual space to the HMD device 110 to the computer 200 via the input/output interface 640.

### Control Device of HMD

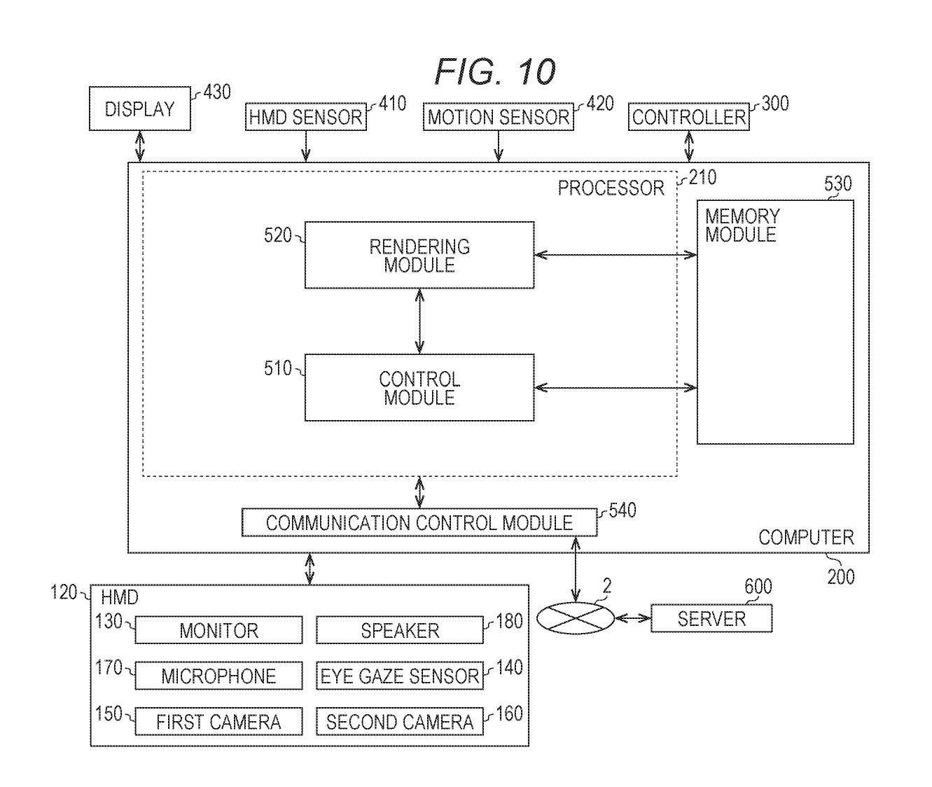

With reference to FIG. 10, the control device of the HMD 21 is described. According to one embodiment of this disclosure, the control device is implemented by the computer 200 having a known configuration. FIG. 10 is a block diagram for illustrating the computer 200 in one embodiment of this disclosure in terms of its module configuration.

As illustrated in FIG. 10, the computer 200 includes a control module 510, a rendering module 520, a memory module 530, and a communication control module 540. In one aspect, the control module 510 and the rendering module 520 are implemented by the processor 210. In another aspect, a plurality of processors 210 may actuate as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. The control module 510 may generate virtual space data by itself or acquire virtual space data from, for example, the server 600.

The control module 510 arranges objects in the virtual space 11 using object data representing objects. The object data is stored in, for example, the memory module 530. The control module 510 may generate virtual space data by itself or acquire object data from, for example, the server 600. The objects may include, for example, an avatar object of the user 5, character objects, operation objects, for example, a virtual hand to be operated by the controller 300, and forests, mountains, other landscapes, streetscapes, and animals to be arranged in accordance with the progression of the story of the game.

The control module 510 arranges an avatar object of the user 5 of another computer 200, which is connected via the network 2, in the virtual space 11. In one aspect, the control module 510 arranges an avatar object of the user 5 in the virtual space 11. In one aspect, the control module 510 arranges an avatar object simulating the user 5 in the virtual space 11 based on an image including the user 5. In another aspect, the control module 510 arranges an avatar object in the virtual space 2, which is selected by the user 5 from among a plurality of types of avatar objects (e.g., objects simulating animals or objects of deformed humans).

The control module 510 identifies an inclination of the HMD 120 based on output of the HMD sensor 410. In another aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In another aspect, the control module 510 may be configured to transmit line-of-sight information representing the line of sight of the user 5 to the server 600. In such a case, the control module 510 may calculate the point-of-view position based on the line-of-sight information received by the server 600.

The control module 510 reflects a motion of the HMD 120, which is detected by the HMD sensor 410, in an avatar object. For example, the control module 510 detects inclination of the HMD 120, and arranges the avatar object in an inclined manner. The control module 510 reflects the detected motion of face parts in a face of the avatar object arranged in the virtual space 11. The control module 510 receives line-of-sight information of another user 5 from the server 600, and reflects the line-of-sight information in the line of sight of the avatar object of another user 5. In one aspect, the control module 510 reflects a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In one aspect, the operation object may include, for example, a hand object serving as a virtual hand corresponding to a hand of the user 5. In one aspect, the control module 510 moves the hand object in the virtual space 11 so that the hand object moves in association with a motion of the hand of the user 5 in the real space based on output of the motion sensor 420. In one aspect, the operation object may correspond to a hand part of an avatar object.

When one object arranged in the virtual space 11 collides with another object, the control module 510 detects the collision. The control module 510 can detect, for example, a timing at which a collision area of one object and a collision area of another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. For example, when an operation object touches with another object, the control module 510 detects the fact that the operation object has touched with another object, and performs predetermined processing.

In one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 510 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs voices (utterances) corresponding to the voice data from the speaker 180.

The memory module 530 holds data to be used to provide the virtual space 11 to the user 5 by the computer 200. In one aspect, the memory module 530 holds space information, object information, and user information.

The space information holds one or more templates defined to provide the virtual space 11.

The object information stores a plurality of panorama images 13 forming the virtual space 11 and object data for arranging objects in the virtual space 11. The panorama image 13 may contain a still image and a moving image. The panorama image 13 may contain an image in a non-real space and an image in the real space. An example of the image in a non-real space is an image generated by computer graphics.

The user information stores a user ID for identifying the user 5. The user ID may be, for example, an internet protocol (IP) address or a media access control (MAC) address set to the computer 200 used by the user. In another aspect, the user ID maybe set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

The communication control module 540 may communicate to/from the server 600 or other information communication devices via the network 2.

In one aspect, the control module 510 and the rendering module 520 may be implemented with use of, for example, Unity (trademark) provided by Unity Technologies. In another aspect, the control module 510 and the rendering module 520 may also be implemented by combining the circuit elements for implementing each step of processing.

The processing performed in the computer 200 is implemented by hardware and software executed by the processor 410. The software may be stored in advance on a hard disk or other memory module 530. The software may also be stored on a CD-ROM or other computer-readable non-volatile data recording media, and distributed as a program product. The software may also be provided as a program product that can be downloaded by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

### Control Structure of HMD System

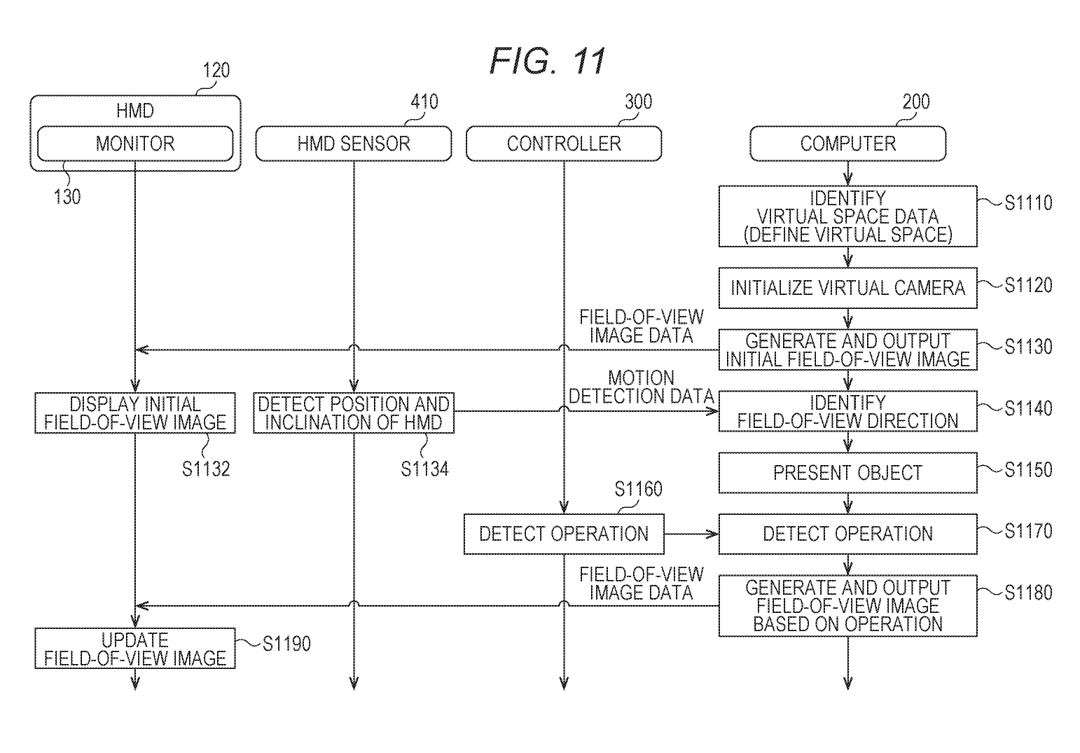

With reference to FIG. 11, the control structure of the HMD set 110 is described. FIG. 11 is a sequence chart for illustrating a part of processing to be executed by the HMD system 100 in one embodiment of this disclosure.

As illustrated in FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In another aspect, an operation of the controller 300 by the user 5 may be detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

### Avatar Object

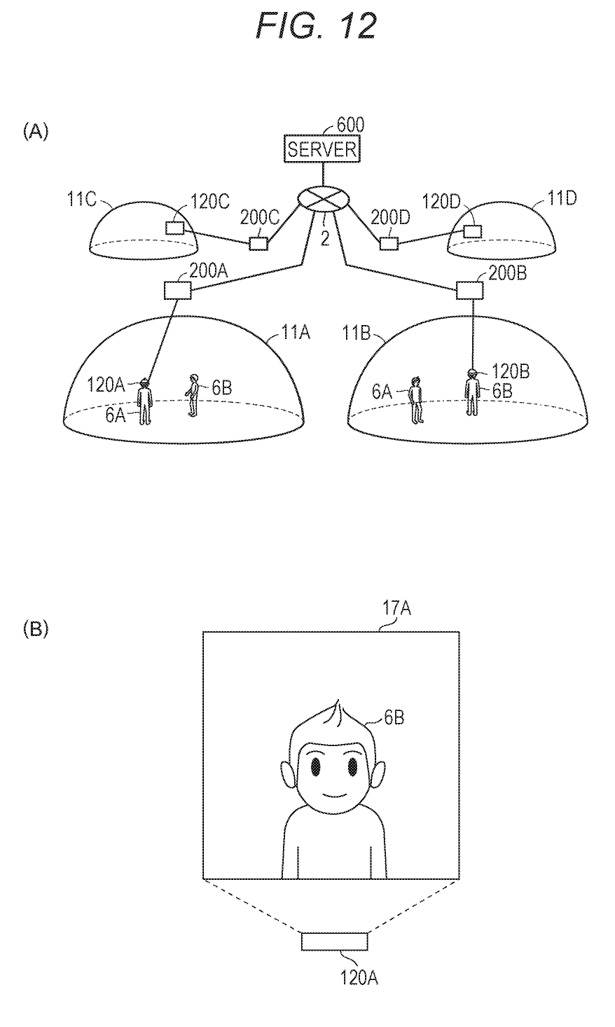

With reference to FIG. 12(A) and FIG. 12 (B), an avatar object in this embodiment is described. FIG. 12(A) and FIG. 12(B) are diagrams for illustrating avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12(A) is a schematic diagram for illustrating a situation in which each HMD 120 provides the user 5 with the virtual space 11. Computers 200A to 200D provide the users 5A to 5D with virtual spaces 11A to 11D via HMDs 120A to 120D, respectively. In the example illustrated in FIG. 12(A), the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, this illustration is only for the sake of simplicity of description, and those objects do not wear the HMD 120 in actuality.

In one aspect, the processor 210A may arrange a virtual camera 14A for photographing a field-of-view region 17A of the user 5A at the position of eyes of the avatar object 6A.

FIG. 12(B) is a diagram for illustrating the field-of-view region 17A of the user 5A in FIG. 12(A). The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not particularly illustrated in FIG. 12B, the avatar object 6A of the user 5A is displayed in the field-of-view image of the user 5B.

Under the state of FIG. 12(B), the user 5A can communicate to/from the user 5B via the virtual space 11A through conversation. More specifically, voices of the user 5A acquired by a microphone 170A are transmitted to the HMD17120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A reflects an operation by the user 5B (operation of HMD 120B and operation of controller 300B) in the avatar object 6B arranged in the virtual space 11A. With this, the user 5A can recognize the operation by the user 5B through the avatar object 6B.

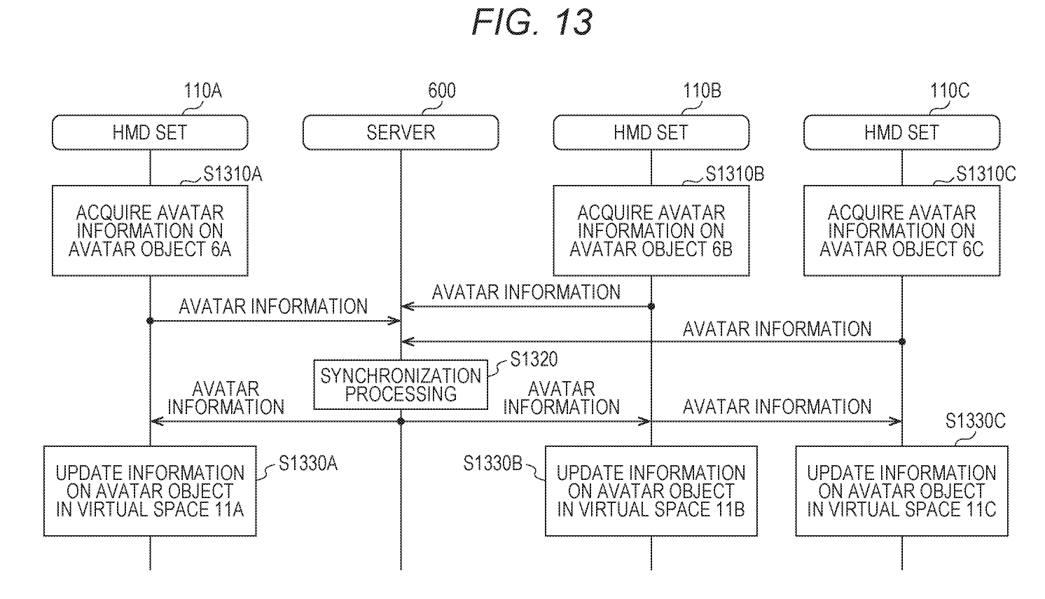

FIG. 13 is a sequence chart for illustrating a part of processing to be executed by the HMD system 100 in this embodiment. In FIG. 13, although the HMD set 110D is not illustrated, the HMD set 110D operates in the same manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. The avatar information may contain information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210B of the HMD set 110B acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD11020C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 540. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

### Detailed Configuration of Modules

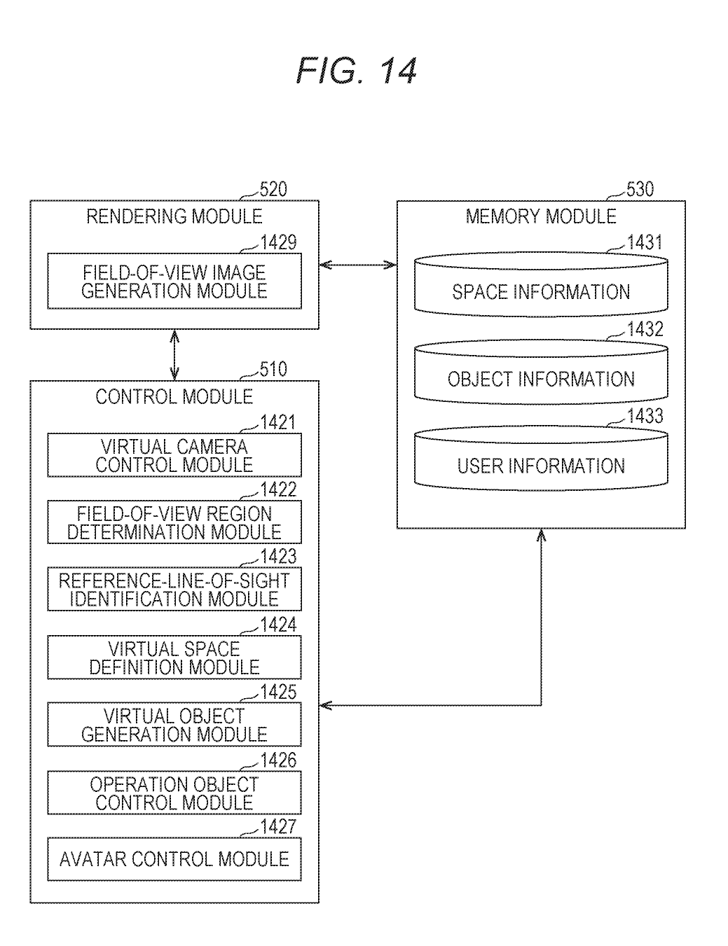

Now, with reference to FIG. 14, a description is given of details of a module configuration of the computer 200. FIG. 14 is a block diagram for illustrating the detailed configuration of modules of the computer 200 in one embodiment of this disclosure.

As illustrated in FIG. 14, the control module 510 includes a virtual camera control module 1421, a field-of-view region determination module 1422, a reference-line-of-sight identification module 1423, a virtual space definition module 1424, a virtual object generation module 1425, an operation object control module 1426, and an avatar control module 1427. The rendering module 520 includes a field-of-view image generation module 1429. The memory module 530 stores space information 1431, object information 1432, user information 1433, and face information 1434.

In one aspect, the control module 510 controls display of an image on the monitor 130 of the HMD 120.

The virtual camera control module 1421 arranges the virtual camera 14 in the virtual space 11. The virtual camera control module 1421 controls a position in the virtual space 11 at which the virtual camera 14 is arranged and the direction (inclination) of the virtual camera 14. The field-of-view region determination module 1422 defines the visually-recognized region 15 based on the direction of the head of the user wearing the HMD 120 and the position at which the virtual camera 14 is arranged. The field-of-view image generation module 1429 generates the field-of-view image 17 to be displayed on the monitor 130 based on the determined visually-recognized region 15.

The reference-line-of-sight identification module 1423 detects the inclination direction (w direction) of the HMD 120 based on the output of the HMD sensor 410. The HMD sensor 410 detects the infrared light output from the HMD 120 to detect the inclination of the HMD 120. In another aspect, the reference-line-of-sight identification module 1423 may identify the line of sight of the user 5 based on a signal from the eye gaze sensor 140.

The control module 510 controls the virtual space 11 to be provided to the user 5. The virtual space definition module 1424 defines the virtual space 11. More specifically, the virtual space definition module 1424 defines the size, the shape, and other conditions of the virtual space 11 to generate the virtual space 11.

The virtual object generation module 1425 generates objects to be arranged in the virtual space 11. The objects may include, for example, forests, mountains, other landscapes, and animals to be arranged in accordance with the progression of the story of the game.

The operation object control module 1426 arranges, in the virtual space 11, an operation object for receiving an operation of the user in the virtual space 11. The user operates the operation object to operate an object arranged in the virtual space 11, for example. In one aspect, the operation object may include, for example, a hand object corresponding to the hand of the user wearing the HMD 120.

The avatar control module 1427 generates data for arranging in the virtual space 11 an avatar object of the user of another computer 200, which is connected via the network. In one aspect, the avatar control module 1427 generates data for arranging an avatar object of the user 5 in the virtual space 11. In one aspect, the avatar control module 1427 generates an avatar object simulating the user 5 based on an image including the user 5. In another aspect, the avatar control module 1427 generates data for arranging in the virtual space 11 an avatar object that is selected by the user 5 from among a plurality of types of avatar objects (e.g., objects simulating animals or objects of deformed humans).

The avatar control module 1427 reflects a motion of the HMD 120, which is detected by the HMD sensor 410, in an avatar object. For example, the avatar control module 1427 detects inclination of the HMD 120, and generates data for arranging the avatar object in an inclined manner. In one aspect, the avatar control module 1427 reflects a motion of the controller 300 in an avatar object. In this case, the controller 300 includes, for example, a motion sensor, an acceleration sensor, or a plurality of light emitting elements (e.g., infrared LEDs) for detecting a motion of the controller 300.

The space information 1431 holds one or more templates defined to provide the virtual space 11.

The object information 1432 stores the panorama image 13 to be developed in the virtual space 11, objects to be arranged in the virtual space 11, and information (e.g., positional information) for arranging the objects in the virtual space 11.

The user information 1433 stores, for example, a program for causing the computer 200 to function as a control device of the HMD system 100, and an application program that uses each type of content stored in the object information 1432.

### Control Structure of Computer 200

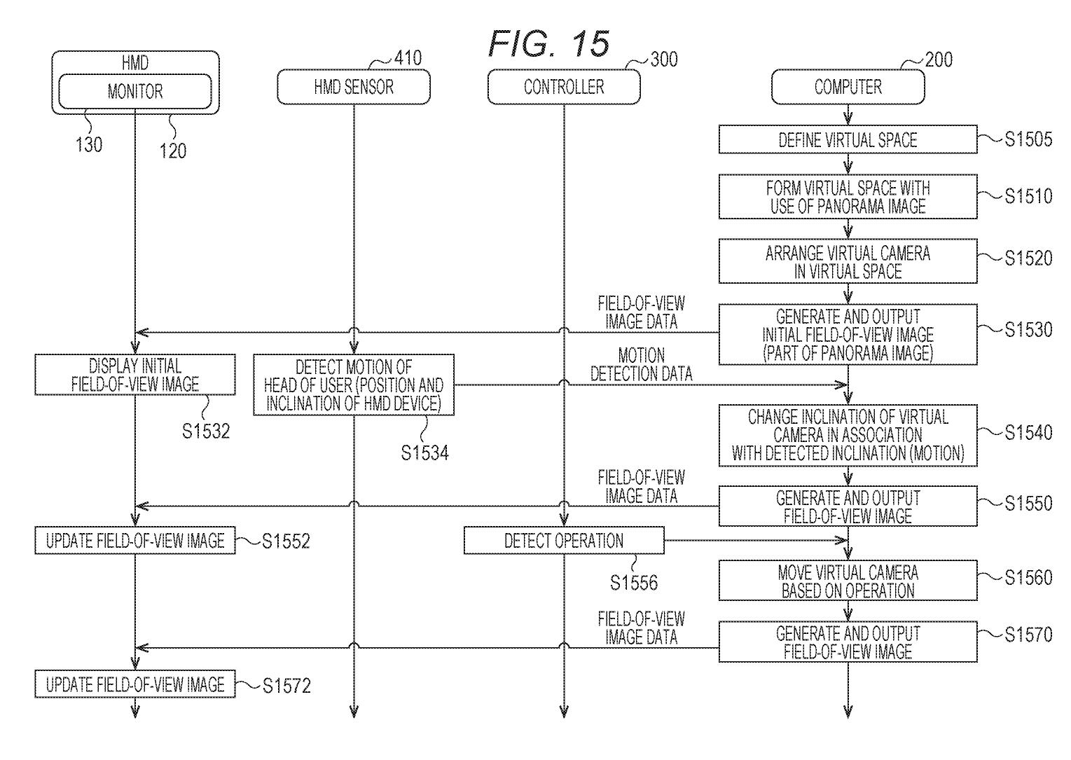

With reference to FIG. 15, the control structure of the computer 200 in one embodiment of this disclosure is described. FIG. 15 is a flowchart for illustrating processing to be executed by the HMD set 110.

In Step S1505, the processor 210 of the computer 200 serves as the virtual space definition module 1424 to define the virtual space 11.

In Step S1510, the processor 210 forms the virtual space 11 with use of the panorama image 13. In other words, the processor 210 develops the panorama image 13 in the virtual space 11.

In Step S1520, the processor 210 arranges the virtual camera 14 in the virtual space 11. At this time, in a work area of the memory, the processor 210 may arrange the virtual camera 14 at the center 12 defined in advance in the virtual space 11.

In Step S1530, the processor 210 serves as the field-of-view image generation module 1429 to generate field-of-view image data for displaying an initial field-of-view image 17 (part of the panorama image 13). The generated field-of-view image data is transmitted to the HMD 120 by the communication control module 540 via the field-of-view image generation module 1429.

In Step S1532, the monitor 130 of the HMD 120 displays the field-of-view image 17 based on a signal received from the computer 200. The user 5 wearing the HMD 120 may recognize the virtual space 11 through visual recognition of the field-of-view image 17.

In Step S1534, the HMD sensor 410 detects the motion of the head of the user 5 (position and inclination of the HMD 120) based on a plurality of infrared rays output from the HMD 120. The detection results are transmitted to the computer 200 as motion detection data.

In Step S1540, the processor 210 detects the inclination (motion) of the HMD 120 based on the motion detection data input from the HMD sensor 410. The processor 210 further changes the inclination of the virtual camera 14 (that is, the reference line of sight 16 of the virtual camera 14) in association with the detected inclination. In this manner, the field-of-view image 17 (that is, a part of the panorama image 13) photographed by the virtual camera 14 is updated.

In Step S1550, the processor 210 serves as the field-of-view image generation module 1429 to generate field-of-view image data for displaying the field-of-view image 17 photographed by the virtual camera 14 whose inclination has been changed, and outputs the generated field-of-view image data to the HMD 120.

In Step S1552, the monitor 130 of the HMD 120 displays the updated field-of-view image based on the received field-of-view image data. In this manner, the user's field of view in the virtual space 11 is updated.

In Step S1556, the controller 300 detects an operation performed by the user 5 in the real space. For example, in one aspect, the controller 300 detects that an analog stick has been tilted forward by the user 5. In another aspect, the controller 300 detects that a button has been depressed by the user 5. The controller 300 transmits a detection signal representing the details of detection to the computer 200.

In Step S1560, the processor 210 serves as the virtual camera control module 1421 to move the virtual camera 14 based on the detection signal. In this manner, the field-of-view image 17 (that is, a part of the panorama image 13) photographed by the virtual camera 14 is updated.

In Step S1570, the processor 210 serves as the field-of-view image generation module 1429 to generate the field-of-view image data for displaying the field-of-view image 17 photographed by the moved virtual camera 14, and outputs the generated field-of-view image data to the HMD 120.

In Step S1572, the monitor 130 of the HMD 120 displays the updated field-of-view image based on the received field-of-view image data. In this manner, the user's field of view in the virtual space 11 is updated.

### Avatar Object

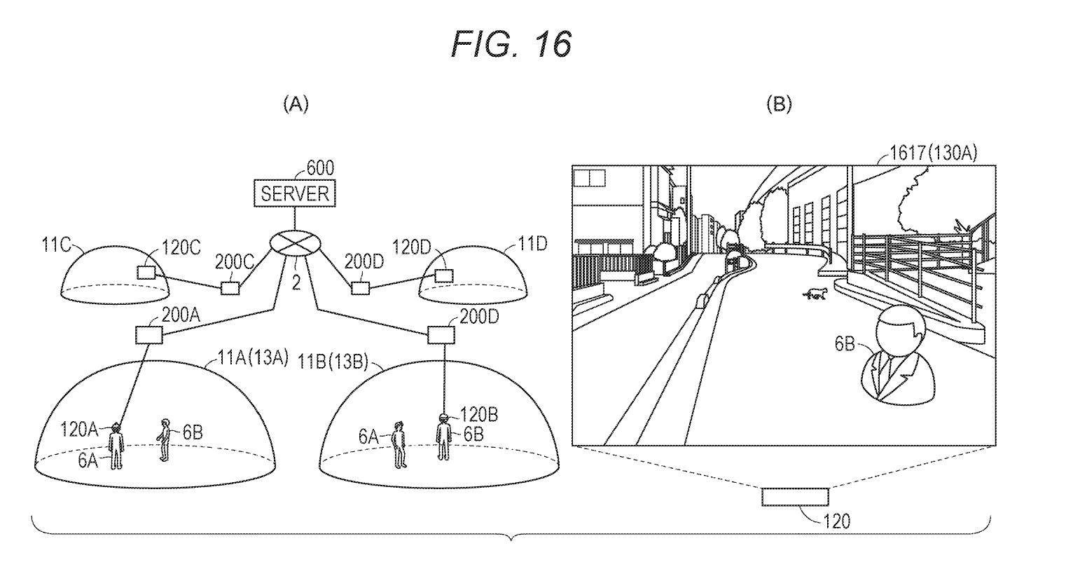

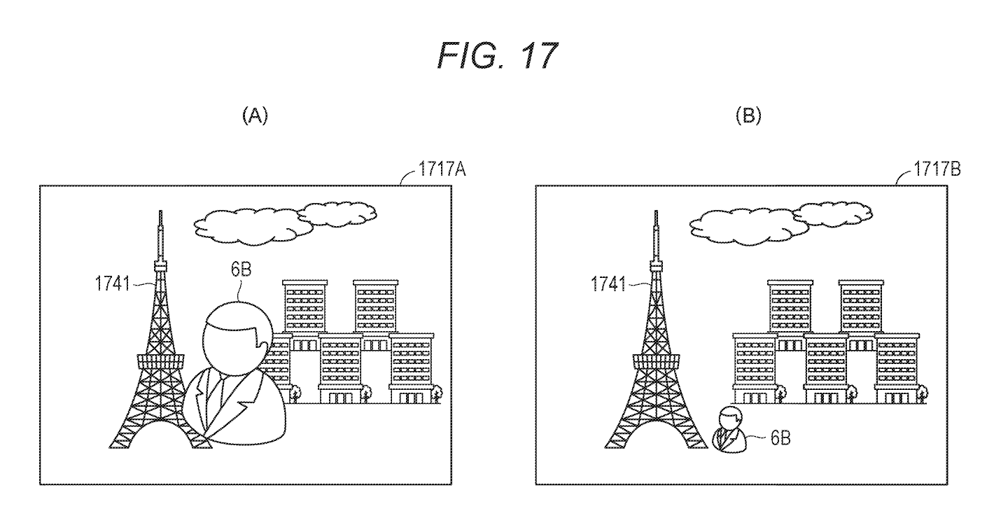

With reference to FIG. 16A and FIG. 16B, an avatar object in this embodiment is described. FIG. 16A and FIG. 16B are diagrams for illustrating avatar objects of respective users of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by a symbol A, a symbol B, a symbol C, and a symbol D, respectively. For example, the HMD 120A is included in the HMD set 110A.

FIG. 16A is a schematic diagram for illustrating a situation in which each of the plurality of HMDs 120 provides each of the plurality of users with the virtual space in the network. With reference to FIG. 16A, computers 200A to 200D provide the users 5A to 5D with virtual spaces 11A to 11D via HMDs 120A to 120D, respectively. In the example illustrated in FIG. 16A, content (e.g., panorama image 17A) included in the virtual space 11A and content (e.g., panorama image 17B) included in the virtual space 11B are the same. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD. However, this illustration is only for the sake of simplicity of description, and those objects do not wear the HMD in actuality.

In one aspect, a virtual camera control module 1421A may arrange a virtual camera 14A for photographing a field-of-view region 17A of the user 5A at the position of eyes of the avatar object 6A.

FIG. 16B is a diagram for illustrating a field-of-view image 1617 of the user 5A. The field-of-view image 1617 is generated by the virtual camera 14A. In FIG. 16A and FIG. 16B, the panorama image 13 of a city landscape in the real space is developed in the virtual space 11A. The avatar object 6B of the user 5B is displayed in the field-of-view image 1617. Although not particularly shown, the city landscape and the avatar object 6A of the user 5A are also displayed similarly in the field-of-view image of the user 5B.

Under the state of FIG. 16B, the user 5A can communicate to/from the user 5B through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

As described above, the avatar control module 1427 reflects an operation by the user 5B (motion of HMD 120B and operation of controller 300B) in the avatar object 6B. With this, the user 5A can recognize the operation by the user 5B through the avatar object 6B.

As described above, the user 5A and the user 5B can communicate to/from each other while sharing the same panorama image 13 on the virtual space . The panorama image 13 may include, for example, movies, live images, images of tourist sights, and images photographed by the user in the past.

### User's Sense of Strangeness of Relationship between Object Forming Virtual Space and Avatar

FIG. 17A and FIG. 17B are illustrations of two field-of-view images including avatar objects having different sizes. Both of FIG. 17A and FIG. 17B are illustrations of field-of-view images to be visually recognized by the user 5A.

With reference to FIG. 17A, a field-of-view image 1717A visually recognized by the user 5A includes a part of the panorama image 13 and the avatar object 6B. The part of the panorama image 13 includes Tokyo Tower (trademark) 1741.

The avatar object 6B is a character object serving as an avatar of the user 5B, and is desired to be sufficiently smaller than the Tokyo Tower 1741. However, in the related art, the avatar object is arranged in the virtual space with a predetermined size. Therefore, in some cases, as illustrated in FIG. 17A, the avatar object 6B is displayed with a size that is substantially the same as that of the Tokyo Tower 1741. In this case, the user 5A may feel a sense of strangeness because the relative size of the avatar object 6B with respect to the object (e.g., Tokyo Tower 1741) displayed in the virtual space 11A is too large. As a result, the user 5A may not be able to concentrate on the communication to/from the user 5B.

Therefore, the HMD system 100 in one embodiment of this disclosure provides the user 5A with a field-of-view image 1717B in which the avatar object 6B is displayed sufficiently smaller than the Tokyo Tower 1741 as illustrated in FIG. 17B. Now, description is given of the configuration and control for adjusting the size of the avatar object with respect to the object displayed in the virtual space 11.

### Control Structure of Server 600

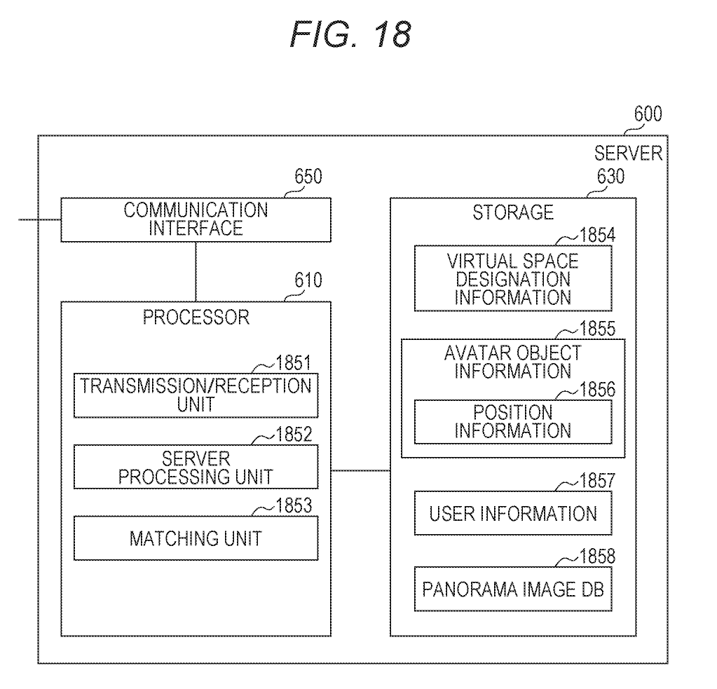

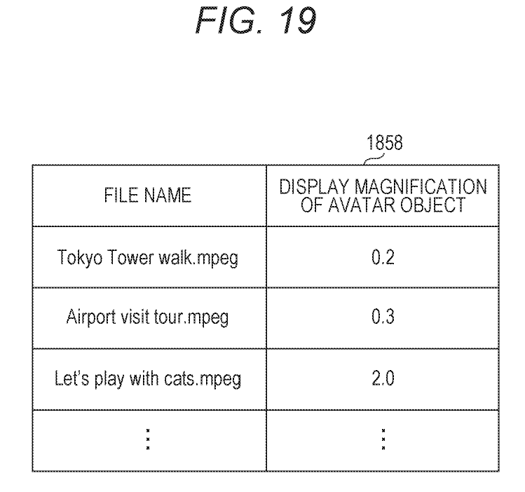

FIG. 18 is a diagram for illustrating an example of a module configuration of the server 600.

The processor 610 executes various control programs stored in the storage 630 to function as a transmission/reception unit 1851, a server processing unit 1852, and a matching unit 1853.

The transmission/reception unit 1851 transmits/receives various kinds of information to/from each computer 200. For example, the transmission/reception unit 1851 transmits to each computer 200 information for defining the virtual space 11 by each computer 200, the panorama image 13 to be developed in the virtual space 11, or voices of the user.

The server processing unit 1852 performs processing required for a plurality of users to share the same virtual space 11. For example, the server processing unit 1852 updates avatar object information 1855 described later based on the information received from the computer 200.

The matching unit 1853 performs a series of processing for associating a plurality of users with one another. For example, when an input operation for the plurality of users to share the same virtual space 11 is performed, the matching unit 1853 performs, for example, processing of associating users belonging to the virtual space 11 to one another.

The storage 630 stores virtual space designation information 1854, the avatar object information 1855, user information 1857, and a panorama image database (DB) 1858.

The virtual space designation information 1854 is information to be used by the virtual space definition module 1424 of the computer 200 to define the virtual space 11. For example, the virtual space designation information 1854 contains information for designating the size of the virtual space 11.

The avatar object information 1855 contains position information 1856. The position information 1856 is information representing a position (coordinates) and direction (reference line of sight 16) of each avatar object in the virtual space 11. The avatar object information 1855 is updated as appropriate based on information input from the computer 200.

The user information 1857 is information on the user 5 of the computer 200. The user information 1857 contains, for example, identification information (e.g., user account) identifying the plurality of users 5.

The panorama image DB 1858 stores the panorama image 13 to be developed in the virtual space 11 by the computer 200.

FIG. 19 is a diagram for illustrating a data structure example of the panorama image DB 1858. With reference to FIG. 19, the panorama image DB 1858 stores the panorama image 13 to be developed in the virtual space 11 by the computer 200 and information for defining the size of the avatar object in the virtual space 11 in association with each other. The information for defining the size of the avatar object is information on a display magnification with respect to a predetermined size of the avatar object (e.g., length in the Y direction of the virtual space 11).

In the example illustrated in FIG. 19, the display magnification of the panorama image 13 of “Tokyo Tower walk.mpeg” is “0.2”. Therefore, when the computer 200 arranges the avatar object in the virtual space 11 in which the panorama image 13 of “Tokyo Tower walk.mpeg” is developed, the computer 200 arranges the avatar object with the size of 0.2 times as large as the predetermined size.

The panorama image DB 1858 may be updated by the user 5 of the computer 200. In this case, the user 5 uploads the panorama image 13 and the display magnification of the avatar object that are associated with each other to the server 600. In another aspect, the panorama image DB 1858 may be updated by a content distributor that manages the server 600. Also in this case, the content distributor stores the panorama image 13 and the display magnification of the avatar object that are associated with each other in the panorama image DB 1858.

### Control of Adjusting Size of Avatar Object

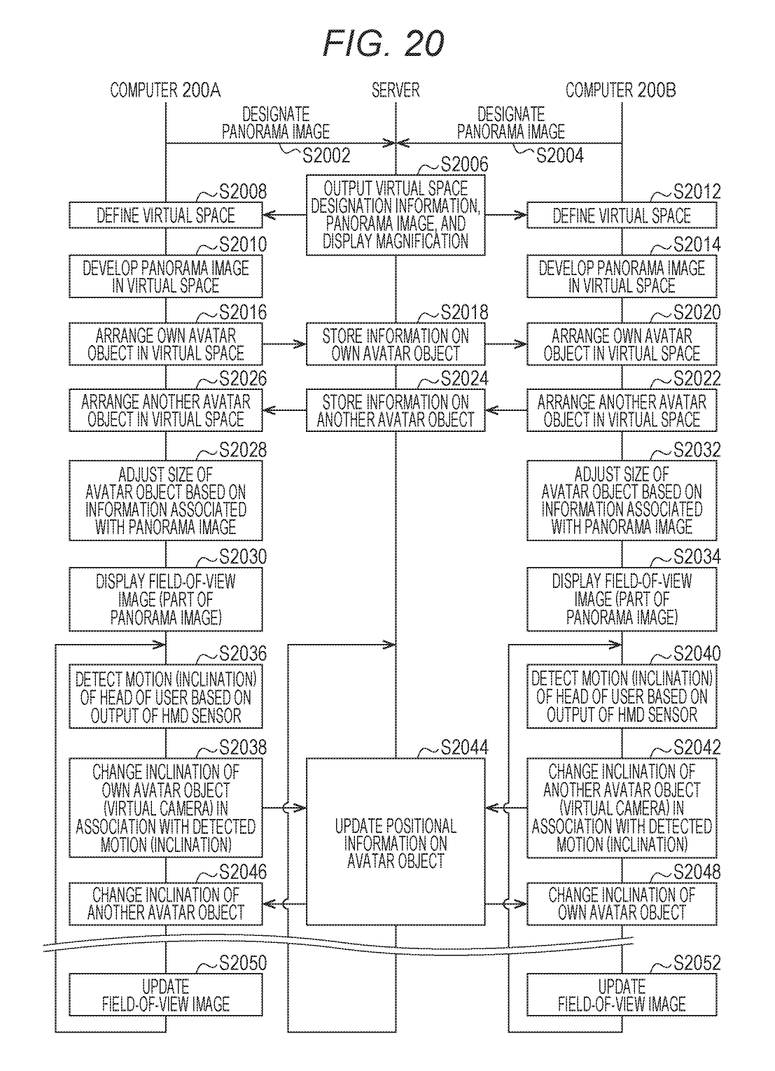

FIG. 20 is a flowchart for illustrating control of adjusting the size of the avatar object in the virtual space 11. The processing illustrated in FIG. 20 may be implemented by the processor 210 of the computer 200 executing a control program stored in the memory 220 or the storage 230 and the processor 610 of the server 600 executing a control program stored in the storage 630.

In Step S2002, the processor 210A of the computer 200A designates, to the server 600, the panorama image 13 to be developed in the virtual space 11A. In Step S2004, the processor 210B of the computer 200B designates, to the server 600, the panorama image 13 to be developed in the virtual space 11B. In Step S2002 and Step S2004, the computers 200A and 200B may additionally output an instruction to share the virtual space 11 to the server 600.

In Step S2006, the processor 610 of the server 600 serves as the transmission/reception unit 1851 to transmit the designated panorama image 13, the virtual space designation information 1854 associated with the panorama image 13, and information on a display magnification to the computers 200A and 200B. Then, the processor 610 may serve as the matching unit 1853 to associate pieces of identification information on the computers 200A and 200B with each other to establish the fact that the users 5A and 5B share the same virtual space.

In Step S2008, the processor 210A serves as a virtual space definition module 1424A to define the virtual space 11A based on the received virtual space designation information 1854. In Step S2010, the processor 210A develops the received panorama image 11 in the virtual space 11A. In other words, the processor 210A forms the virtual space 11A with use of the panorama image 11.

In Step S2012, the processor 210B serves as the virtual space definition module 1424B to define the virtual space 11B based on the received virtual space designation information 1854. In Step S2014, the processor 210B develops the received panorama image 13 in the virtual space 11B.

In Step S2016, the processor 210A serves as an avatar control module 1427A to arrange the avatar object 6A (denoted by “own avatar object” in FIG. 20) of the user 5A himself or herself in the virtual space 11A. Then, the processor 210A transmits information (e.g., data for modeling and positional information) on the avatar object 6A to the server 600.

In Step S2018, the processor 610 stores the received information on the avatar object 6A into the storage 630 (avatar object information 1855). The processor 610 further transmits the information on the avatar object 6A to the computer 200B sharing the same virtual space 11 with the computer 200A.

In Step S2020, the processor 210B serves as an avatar control module 1427B to arrange the avatar object 6A in the virtual space 11B based on the received information on the avatar object 6A.

Similarly to Step S2016 to Step S2020, in Step S2022 to Step S2026, the avatar object 6B is generated in the virtual spaces 11A and 11B (denoted by “another avatar object” in FIG. 20), and information on the avatar object 6B is stored into the storage 630.

In Step S2028, the processor 210A serves as the avatar control module 1427A to adjust the sizes of the avatar objects 6A and 6B to be arranged in the virtual space 11A based on the information associated with the panorama image 13, that is, the information on the display magnification. For example, when the display magnification is “0.3”, the processor 210A sets the sizes of the avatar objects 6A and 6B to 0.3 times as large as the predetermined size (e.g., length in the Y direction of the virtual space 11).

In Step S2030, the processor 210A serves as the field-of-view image generation module 1429 to display the field-of-view image (part of the panorama image 13) photographed by the virtual camera 14A on the monitor 130A of the HMD 120A. In this manner, the user 5A visually recognizes the avatar object 6B of the user 5B whose size is adjusted. The virtual camera control module 1421A may arrange the virtual camera 14A at the position of the eyes of the avatar object 6A.

In Step S2032 and Step S2034, similarly to the processor 210A, the processor 210B adjusts the sizes of the avatar objects 6A and 6B, and displays the field-of-view image photographed by the virtual camera 14B on the monitor 30B.

In Step S2036, the processor 210A detects the motion (inclination) of the head of the user 5A based on the output of the HMD sensor 410. In another aspect, the processor 210A detects the motion of the head of the user 5A based on the output of the HMD 120 (output of the sensor 190).

In Step S2038, the processor 210A serves as the avatar control module 1427A to change the inclination of the avatar object 6A in association with the detected motion (inclination) of the head of the user 5A. The processor 210A further transmits inclination information representing the inclination of the avatar object 6A after the change to the server 600. In another aspect, the processor 210A may be configured to transmit information representing an inclination change amount of the avatar object 6A before and after the change to the server 600.

In Step S2040 and Step S2042, similarly to the processor 210A, the processor 210B changes the inclination of the avatar object 6B in association with the motion of the head of the user 5B. In Step S2042, the processor 210B further transmits inclination information on the avatar object 6A after the change to the server 600.

In Step S2044, the processor 610 serves as the server processing unit 1852 to update the position information 1856 corresponding to the avatar object 6A based on the inclination information received from the computer 200A. The processor 610 further updates the position information 1856 corresponding to the avatar object 6B based on the inclination information received from the computer 200B.

In Step S2044, the processor 610 further serves as the transmission/reception unit 1851 to transmit the inclination information received from the computer 200A to the computer 200B. The processor 610 transmits the inclination information received from the computer 200B to the computer 200A.

In Step S2046, the processor 210A serves as the avatar control module 1427A to change an inclination of the avatar object 6B based on the received positional information 1856. In Step S2048, the processor 210B serves as the avatar control module 1427B to change an inclination of the avatar object 6A based on the received positional information 1856.

In Step S2050, the processor 210A displays, on the monitor 130A, an image photographed by the virtual camera 14A arranged at the position of the eyes of the avatar object 6A. As a result, a field-of-view image visually recognized by the user 5A is updated. After that, the processor 210A returns the processing to Step S2036.

In Step S2052, similarly to the processor 210A, the processor 210B displays an image photographed by the virtual camera 14B on the monitor 130B. With this, a field-of-view image visually recognized by the user 5B is updated. After that, the processor 210B returns the processing to Step S2040.

In one embodiment of this disclosure, the processing of Step S2036 to S2052 may be executed repeatedly at an interval of 1/60 second or 1/30 second.

According to the above, the HMD system 100 in one embodiment of this disclosure can adjust the size of the avatar object 6 to be arranged in the virtual space 11 based on the information (information on the display magnification) associated with the panorama image 13. In this manner, the HMD system 100 can adjust the relative size of the avatar object with respect to the object displayed on the virtual space 11. As a result, the user 5 using the HMD system 100 can concentrate on the communication to/from other users communicating via the virtual space. As described above, the HMD system 100 in one embodiment of this disclosure can enhance the experience of the user 5 in the virtual space.

In the above-mentioned example, the computer 200 is configured to arrange the avatar object 6 in the virtual space 11, and then adjust the size of the avatar object 6. In another aspect, the computer 200 may be configured to adjust the size of the avatar object 6 in advance, and then arrange the avatar object 6 in the virtual space 11.

In another aspect, the above-mentioned repeatedly executed processing may include processing of transmitting voices of the user 5 to the computer 200 of the partner, processing of changing coordinate positions of the avatar objects 6A and 6B, and other processing of enhancing communication between users in the virtual space 11.

In the example described above, in Step S2016 and in Step S2022, the computer 200 arranges the avatar object 6 of the user of the computer 200 in the virtual space 11. In another aspect, the processing in Step S2016 and in Step S2022 may be omitted because the user can communicate to/from a partner as long as the avatar object of the partner is arranged in the virtual space 11.

### Adjustment of Size of Avatar based on Information for Identifying Object Included in Panorama Image

In the above-mentioned embodiment, the computer 200 is configured to adjust the size of the avatar object 6 based on the information on the display magnification associated with the panorama image 13. However, the information on the display magnification may not be associated with the panorama image 13. For example, the user 5 may upload the panorama image 13 to the server 600 without associating the information on the display magnification with the panorama image 13. Now, description is given of a technology that enables the size of the avatar object 6 to be adjusted even in such a case. The configuration of the HMD system in this embodiment is substantially the same as the configuration of the HMD system described above. Therefore, only different parts are described below.

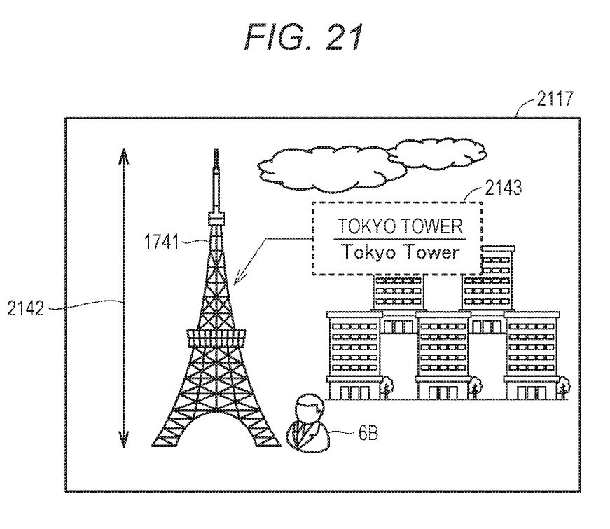

FIG. 21 is a diagram for illustrating information for identifying an object included in the panorama image (hereinafter also referred to as “tag information”). With reference to FIG. 21, a field-of-view image 2117 visually recognized by the user 5A includes tag information 2143 in addition to the avatar object 6B and the Tokyo Tower 1741.

The tag information 2143 is information for identifying the Tokyo Tower 1741. In the example illustrated in FIG. 21, the tag information 2143 includes a character string of “Tokyo Tower”. The user 5A can visually recognize the tag information 2143 to understand that the object indicated by the tag information 2143 is the Tokyo Tower. As described above, in one aspect, the tag information may be associated with the panorama image 13.

The HMD system 100 in this embodiment adjusts the size of the avatar object 6 with use of this tag information. With reference to the example of FIG. 21, description is given of processing of determining the display magnification of the avatar object 6 based on the tag information by the processor 610 of the server 600.

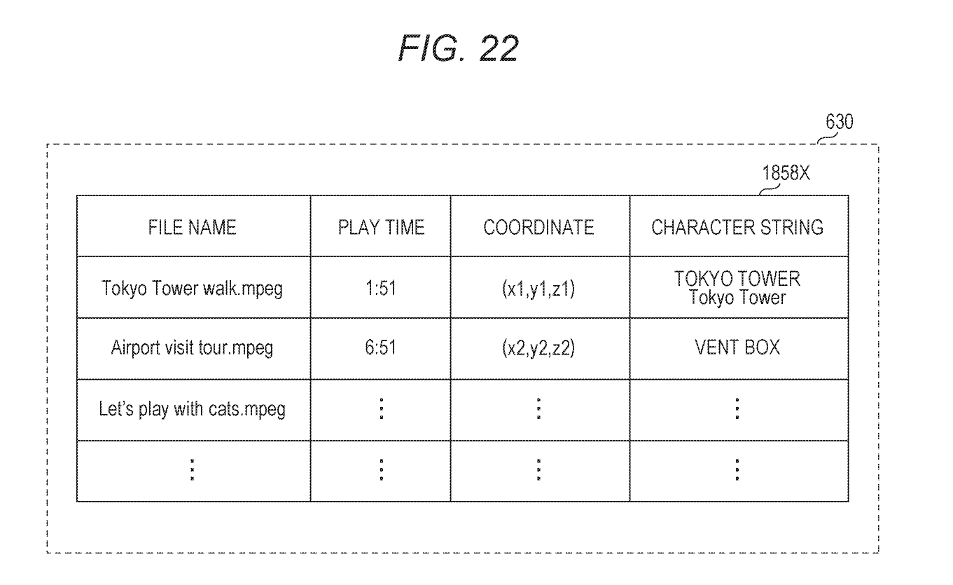

First, the processor 610 identifies that an object indicated by the tag information 2143 (hereinafter also referred to as “identification target”) is the Tokyo Tower 1741. As described with reference to FIG. 22 later, the tag information 2143 may include information on coordinates in the virtual space 11 of the identification target in addition to the character string of “Tokyo Tower”. The processor 610 may identify that the object indicated by the tag information 2143 is the Tokyo Tower 1741 based on this coordinate information.

The processor 610 calculates the size of the identification target (that is, the Tokyo Tower 1741) in the virtual space 11. As an example, the processor 610 sets a length 2142 of the identification target in the Y direction (height direction) of the virtual space 11 as the size of the identification target.

Next, the processor 610 identifies the size of the identification target in the real space. As an example, the processor 610 identifies the size of the object indicated by the term (“Tokyo Tower”) included in the character string of the tag information 2143 with use of a search engine (e.g., Google (trademark)) connected to the network 2.

The processor 610 may determine the display magnification of the avatar object 6 so that a ratio between the size of the identification target in the real space and an average size of a human (e.g., 160 cm) becomes equal to a ratio between the size of the identification target in the virtual space and the size of the avatar object 6. As illustrated in FIG. 21, when the avatar object 6 includes not the whole body but only an upper part from the shoulders, the processor 610 may determine the display magnification of the avatar object 6 in view of this fact. As described above, the HMD system in one embodiment of this disclosure can adjust the size of the avatar object 6 based on the tag information associated with the panorama image.

FIG. 22 is a diagram for illustrating a data structure example of a panorama image DB 1858X. In one aspect, the server 600 may further store the panorama image DB 1858X into the storage 630. The panorama image DB 1858X stores the panorama image 13 and tag information in association with each other. The tag information includes coordinates and character strings. The coordinates are coordinates at which the identification target is displayed in the virtual space 11. The character strings include information for identifying the identification target.

In one aspect, the panorama image 13 may be a moving image. In this case, the tag information may further include a play time (timing) to display the character string in the above-mentioned parameters.

In the example illustrated in FIG. 22, when the panorama image “Tokyo Tower walk.mpeg” is developed (played) in the virtual space 11, the character string “Tokyo Tower” for identifying an object displayed at the coordinates (x1, y1, z1) at the timing of the play time of 1:51 is displayed on the virtual space 11.

The panorama image DB 1858X may be updated by the user 5 of the computer 200. In this case, the user 5 uploads the panorama image 13 and the tag information to the server 600 in association with each other. In another aspect, the panorama image DB 1858X may be updated by a content distributor that manages the server 600. Also in this case, the content distributor stores the panorama image 13 and the tag information into the panorama image DB 1858X in association with each other.

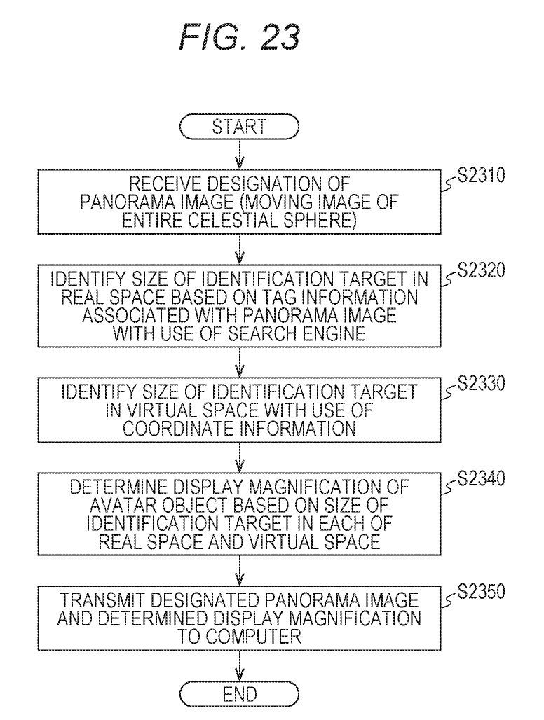

With reference to FIG. 23, description is given of the processing of determining the display magnification of the avatar object 6 based on the tag information. FIG. 23 is a flowchart for illustrating the processing of determining the display magnification of the avatar object 6 by the server 600 in Step S2012 of FIG. 20. The processing illustrated in FIG. 23 may be executed by the processor 610 of the server 600 executing a control program stored in the storage 630.

In Step S2310, the processor 610 receives, from the computer 200, designation of the panorama image (e.g., moving image of the entire celestial sphere) to be developed in the virtual space 11 by the computer 200.

In Step S2320, the processor 610 identifies the size of the identification target in the real space. More specifically, the processor 610 identifies the size of the identification target in the real space based on the character string included in the tag information associated with the designated panorama image with use of a search engine connected to the network 2.

In Step S2330, the processor 610 identifies the size of the identification target in the virtual space 11. More specifically, the processor 610 detects the identification target in the virtual space 11 from the coordinate information included in the tag information to identify the size of the identification target in the virtual space 11.

In Step S2340, the processor 610 determines the display magnification of the avatar object 6 based on the size of the identification target in each of the real space and the virtual space. More specifically, the processor 610 determines the display magnification of the avatar object 1100 so that the ratio between the size of the identification target in the real space and an average size of a human becomes equal to the ratio between the size of the identification target in the virtual space and the size of the avatar object 6.

In Step S2350, the processor 610 transmits the designated panorama image and the determined display magnification to the computer 200.

According to the above, the HMD system in one embodiment of this disclosure can adjust the size of the avatar object 6 based on the tag information associated with the panorama image.

In the above-mentioned example, the processor 610 of the server 600 performs the processing of calculating the display magnification of the avatar object 6 after receiving the designation of the panorama image from the computer 200. In another aspect, when a new panorama image is added to the panorama image DB 1858X, the processor 610 may calculate the display magnification of the avatar object 6 with respect to the new panorama image. The processor 610 may store the calculated display magnification into the panorama image DB 1858X.

In another aspect, the processor 610 of the server 600 may be configured to transmit the panorama image and the tag information associated with the panorama image to the computer 200. In this case, the computer 200 may calculate the display magnification of the avatar object 6 in accordance with the above-mentioned processing.

### Adjustment of Size of Avatar based on Size of Object Included in Panorama Image

The above-mentioned HMD system in one embodiment of this disclosure is configured to adjust the size of the avatar object based on the information associated with the panorama image 13 (display magnification or information for identifying an object included in the panorama image 13). However, information may not be associated with the panorama image 13. Now, description is given of a technology that enables the size of the avatar object 6 to be adjusted even in such a case. The configuration of the HMD system in this embodiment is substantially the same as the configuration of the HMD system described above. Therefore, only different parts are described below.

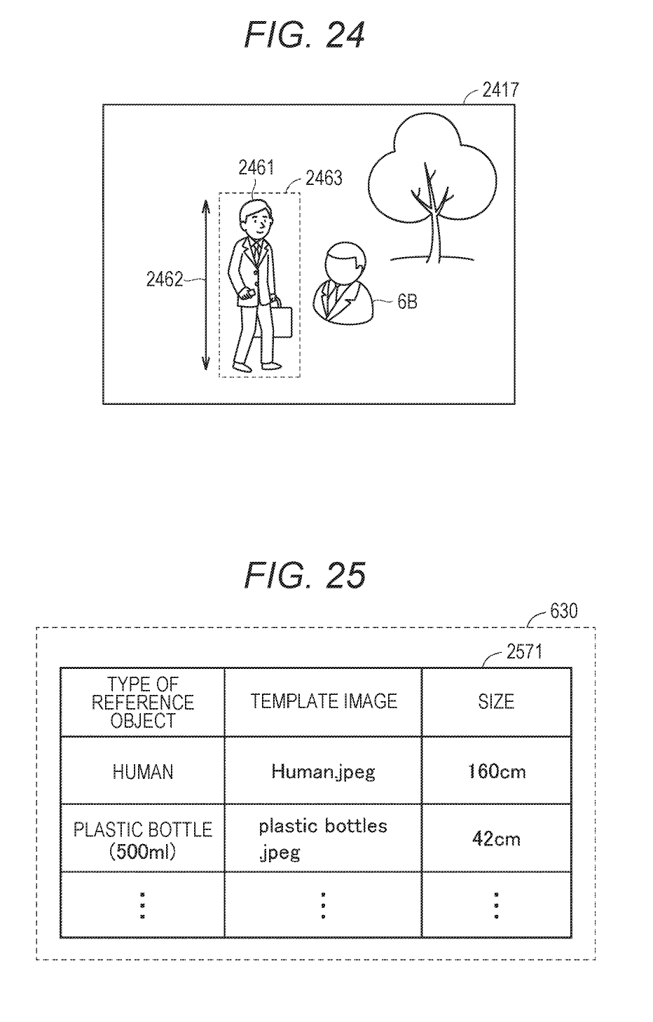

FIG. 24 is a diagram for illustrating the processing of adjusting the size of the avatar object 6. With reference to FIG. 24, a field-of-view image 2417 visually recognized by the user 5A includes an avatar object 6B and a human 2461.

In one aspect, when the processor 610 of the server 600 determines that no information is associated with the panorama image corresponding to the field-of-view image 2417, the processor 610 searches for an object (hereinafter also referred to as “reference object”) whose size in the real space may be identified to some extent from the panorama image. As an example, the processor 610 uses a template DB 2571 illustrated in FIG. 25 to search fora reference object from the panorama image.

FIG. 25 is a diagram for illustrating a data structure example of the template DB 2571 in one embodiment of this disclosure. The template DB 2571 is stored in the storage 630 of the server 600.

The template DB 2571 stores the type of the reference object, a template image corresponding to the reference object, and the size of the reference object in the real space in association with one another. As an example, the reference object may include a human, a plastic bottle (e.g., 500 ml size), and a street light. In the example of FIG. 25, the template DB 2571 stores one template image corresponding to a reference object, but in another aspect, the template DB 2571 may store a plurality of template images.

Referring again to FIG. 24, the processor 610 sets a comparison region on a rectangle in the panorama image 13. The processor 610 calculates the similarity between the image in the comparison region and each template image included in the template DB 2571 while changing the size, the position, and the angle of the comparison region. The processor 610 refers to the template DB 2571 to identify the size in the real space of the reference object corresponding to the template image for which the similarity is calculated to be larger than a predetermined threshold value. The processor 610 further identifies the length in the Y direction (height direction) of the comparison region in which the similarity is calculated to be larger than a predetermined threshold value. In one aspect, the processor 610 identifies the length of the comparison region as the size of the reference object in the virtual space 11.

In the example illustrated in FIG. 24, the processor 610 detects a comparison region 2463 including the human 2461 as the reference object from the panorama image 13 corresponding to the field-of-view image 2417. The processor 610 may further identify a length 2462 of the comparison region 2463 in the Y direction as the size of the human in the virtual space.

The processor 610 determines the display magnification of the avatar object 6 so that a ratio between the size of the reference object in the real space and an average size of a human (e.g., 160 cm) becomes equal to a ratio between the size of the reference object in the virtual space and the size of the avatar object 6. In another aspect, when the reference object is a human, the processor 610 may set the display magnification of the avatar object 6 so that the size of the reference object in the virtual space becomes equal to the size of the avatar object 6. As illustrated in FIG. 24, when the avatar object 6 includes not the whole body but only an upper part from the shoulders, the processor 610 may determine the display magnification of the avatar object 6 in view of this fact.

According to the above, the HMD system in one embodiment of this disclosure can adjust the size of the avatar object 6 even when no information is associated with the panorama image 13.

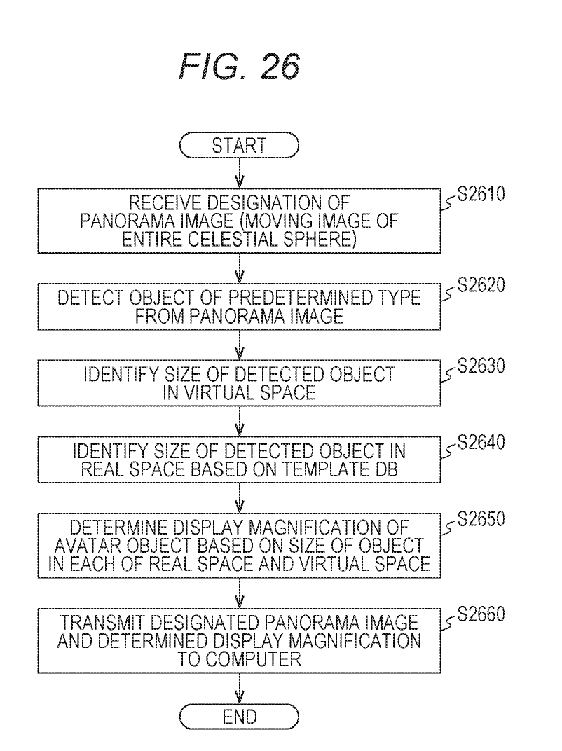

With reference to FIG. 26, description is given of the processing of determining the display magnification of the avatar object 6 when no information is associated with the panorama image 13. FIG. 26 is a flowchart for illustrating the processing of determining the display magnification of the avatar object 6 by the server in Step S2012 of FIG. 20. The processing illustrated in FIG. 26 may be executed by the processor 610 of the server 600 executing a control program stored in the storage 630.

In Step S2610, the processor 610 receives, from the computer 200, designation of the panorama image (e.g., moving image of entire celestial sphere) to be developed in the virtual space 11 by the computer 200.

In Step S2620, the processor 610 detects an object of a predetermined type (that is, the reference object) from the designated panorama image 13. In Step S2630, the processor 610 identifies the size of the detected object (reference object) in the virtual space 11.

In Step S2640, the processor 610 refers to the template DB 2571 stored in the storage 630 to identify the size of the detected object (reference object) in the real space.

In Step S2650, the processor 610 determines the display magnification of the avatar object 6 based on the size of the detected object (reference object) in each of the real space and the virtual space. More specifically, the processor 610 determines the display magnification of the avatar object 6 so that the ratio between the size of the reference object in the real space and an average size of a human becomes equal to the ratio between the size of the reference object in the virtual space and the size of the avatar object 6.

In Step S2660, the processor 610 transmits the designated panorama image and the determined display magnification to the computer 200.

According to the above, the HMD system in one embodiment of this disclosure can adjust the size of the avatar object 6 even when no information is associated with the panorama image 13. In this manner, the user is less likely to feel the sense of strangeness of the relative size of the avatar object with respect to the object displayed in the virtual space 11. As a result, the user can concentrate on communication to/from other users communicating via the virtual space. As described above, the HMD system in one embodiment of this disclosure can enhance the user's experience in the virtual space.

### Configurations

The technical features disclosed above may be summarized in the following manner.

### Configuration 1

According to one embodiment of this disclosure, there is provided a method for adjusting a size of an avatar object 6 in a virtual space 11. The method includes the steps of: forming (S2010) the virtual space 11 with use of a panorama image 13; displaying (S2030) a part of the panorama image 13 on a monitor 130 of an HMD 120; detecting (S2036) a motion of a head of a user 5 wearing the HMD 120; updating (S2050) the part of the panorama image 13 displayed on the HMD 120 in association with the detected motion; arranging (S2026) the avatar object 6 of the user communicating via the virtual space 11 in the virtual space 11; and adjusting (S2028) the size of the avatar object 6 based on information associated with the panorama image 13. In one aspect, this method may be executed by a computer 200.

### Configuration 2

According to one embodiment of this disclosure, the associated information includes a display magnification of the avatar object 6.

### Configuration 3

According to one embodiment of this disclosure, the associated information includes information for identifying an object included in the panorama image 13. The step of adjusting the size of the avatar object 6 includes identifying (S2320, S2330) a size of an object (identification target) in each of the virtual space 11 and a real space, and adjusting (S2340) the display magnification of the avatar object 6 based on the identified size of the object in each of the virtual space 11 and the real space. The identifying (S2320, S2330) the size of the object (identification target) in each of the virtual space 11 and the real space may be executed by the computer 200 or a server 600.

### Configuration 4

According to one embodiment of this disclosure, there is provided a method for adjusting a size of an avatar object 6 in a virtual space 11. The method includes the steps of: forming (S2610), by a computer 200, a virtual space 11 with use of a panorama image 13; displaying (S2030), by the computer 200, a part of the panorama image 13 on a monitor 130 of an HMD 120; detecting (S2036) a motion of a head of a user 5 wearing the HMD 120; updating (S2050), by the computer 200, the part of the panorama image 13 displayed on the HMD 120 in association with the detected motion; arranging (S2026), by the computer 200, the avatar object 6 of the user communicating via the virtual space 11 in the virtual space 11; and adjusting (S2650), by the computer 200 or a server 600, the size of the avatar object 6 based on a size of a reference object included in the panorama image 13.

### Configuration 5

According to one embodiment of this disclosure, the step of adjusting the size of the avatar object 6 includes: detecting (S2620) the reference object from the panorama image 13; identifying (S2630, S2640) the size of the reference object in each of the virtual space 11 and a real space; and adjusting (S2650) a display magnification of the avatar object 6 based on the identified size of the reference object.

### Configuration 6

According to one embodiment of this disclosure, the reference object (predetermined type of object) includes a human.

### Configuration 7

According to one embodiment of this disclosure, the panorama image 13 includes a moving image.

### Configuration 8

According to one embodiment of this disclosure, the panorama image 13 includes an image of an entire celestial sphere.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the embodiment described above, the description is given by exemplifying the virtual space (VR space) in which the user is immersed using an HMD. However, in at least one embodiment, a see-through HMD is adopted as the HMD. In this case, in at least one embodiment, the user is provided with a virtual experience in an augmented reality (AR) space or a mixed reality (MR) space through output of a field-of-view image that is a combination of the real space recognized by the user via the see-through HMD and a part of an image forming the virtual space. In this case, in at least one embodiment, action is exerted on a target object in the virtual space based on motion of a hand of the user instead of the operation object. Specifically, in at least one embodiment, the processor identifies coordinate information on the position of the hand of the user in the real space, and defines the position of the target object in the virtual space in connection with the coordinate information in the real space. With this, the processor is able to grasp a positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

1. A method to be executed by a computer including a processor and a memory, the method comprising:
storing, into the memory, data for defining each of a panorama image, first information associated in advance with the panorama image, an avatar object having a predetermined size, and a point of view;
forming a virtual space with use of the panorama image;
adjusting a size of the avatar object so as to correspond to the first information;
arranging the avatar object having the adjusted size in the virtual space;
detecting a motion of a head-mounted device (HMD);
defining a field of view from the point of view based on the detected motion of the HMD;
generating a field-of-view image corresponding to the field of view; and
displaying the field-of-view image on the HMD.

2. A method according to claim 1,
wherein the first information defines a magnification for changing the size of the avatar object from the predetermined size, and
wherein the size of the avatar object is adjusted to a size corresponding to the magnification.

3. A method according to claim 2,
wherein the panorama image includes a first image that is an image representing a first object present in a real space, and
wherein the method further comprises:
identifying a size of the first object in the virtual space based on the first image; and
defining the magnification based on the size of the first object in the virtual space.

4. A method according to claim 2, further comprising:
storing, into the memory, second information for identifying the first object in association with the panorama image;
identifying a size of the first object in the real space based on the second information; and
defining the magnification based on the size of the first object in the real space.

5. A method according to claim 2,
wherein the panorama image includes a first image that is an image representing a first object present in a real space, and
wherein the method further comprises:
storing second information for identifying the first object into the memory in association with the panorama image;
identifying a size of the first object in the virtual space based on the first image;
identifying a size of the first object in the real space based on the second information;
identifying a ratio between the size of the first object in the real space and the size of the first object in the virtual space; and
defining the magnification based on the ratio.

6. A method according to claim 3, wherein the first object includes a human.
